(19) United States
(12) Patent Application Publication
(10) Pub. No.: US 2024/0130061 A1
(43) Pub. Date: Apr. 18, 2024

(54) FOLDABLE APPARATUS AND METHODS OF MAKING

(71) Applicant: CORNING INCORPORATED, CORNING, NY (US)

(72) Inventors: TIMOTHY MICHAEL GROSS, PAINTED POST, NY (US); TIMOTHY PAUL SMITH, PAINTED POST, NY (US); WENDELL PORTER WEEKS, CORNING, NY (US)

(21) Appl. No.: 18/277,125

(22) PCT Filed: Feb. 10, 2022
(86) PCT No.: PCT/US2022/015896

§ 371 Date: Aug. 14, 2023

Related U.S. Application Data
(60) Provisional application No. 63/151,210, filed on Feb. 19, 2021.

(51) Int. Cl. H05K 5/02; C03B 23/027; C03B 23/03; C03B 25/02; C03C 21/00

(52) U.S. Cl. CPC H05K 5/0217; C03B 23/027; C03B 23/03; C03B 25/025; C03C 21/002

(57) ABSTRACT

Foldable apparatus comprise a foldable substrate comprising a substrate thickness. The second major surface of the foldable substrate faces an end portion of a first inner surface area of a first housing member extending along a first plane. The second surface faces an end portion of a second inner surface area of a second housing member extending along a second plane. A support is attached to at least the second housing member. The support contacts the second major surface when an angle between the first plane and the second plane ranges from about 80° to about 135°. The support is spaced from the second major surface when an angle between the first plane and the second plane ranges from about 0° to about 30°. In some embodiments, the foldable substrate comprises a neutral stress configuration at a parallel plate distance ranging from about 20 millimeters to about 200 millimeters.

### CROSS-REFERENCE TO RELATED APPLICATION

This application claims the benefit of priority under 35 U.S.C. § 119 of U.S. Provisional Application Ser. No. 63/151,210 filed on Feb. 19, 2021, the content of which is relied upon and incorporated herein by reference in its entirety.

### FIELD

The present disclosure relates generally to foldable apparatus and methods of making and, more particularly, to foldable apparatus comprising portions and methods of making foldable apparatus comprising a support.

### BACKGROUND

Glass-based substrates are commonly used, for example, in display devices, for example, liquid crystal displays (LCDs), electrophoretic displays (EPD), organic light-emitting diode displays (OLEDs), plasma display panels (PDPs), or the like.

There is a desire to develop foldable versions of displays as well as foldable protective covers to mount on foldable displays. Foldable displays and covers should have good impact and puncture resistance. At the same time, foldable displays and covers should have small minimum bend radii (e.g., about 10 millimeters (mm) or less). However, plastic displays and covers with small minimum bend radii tend to have poor impact and/or puncture resistance. Furthermore, conventional wisdom suggests that ultra-thin glass-based sheets (e.g., about 75 micrometers (μm or microns) or less thick) with small minimum bend radii tend to have poor impact and/or puncture resistance. Furthermore, thicker glass-based sheets (e.g., greater than 125 micrometers) with good impact and/or puncture resistance tend to have relatively large minimum bend radii (e.g., about 30 millimeters or more). Consequently, there is a need to develop foldable apparatus that have low minimum bend radii and good impact and puncture resistance.

### SUMMARY

There are set forth herein foldable apparatus and methods of making foldable apparatus that comprise a foldable substrate. In some embodiments, the foldable substrate can comprise a fictive temperature substantially equal to an anneal point temperature and/or a neutral stress configuration in a non-planar configuration. The foldable substrate can comprise a glass-based substrate and/or a ceramic-based substrate, which can provide good impact resistance and/or good puncture resistance to the foldable apparatus. The foldable substrate can comprise a glass-based substrate and/or a ceramic-based substrate comprising one or more compressive stress regions, which can further provide increased impact resistance and/or increased puncture resistance. Providing a foldable substrate comprising a glass-based substrate and/or ceramic-based substrate can also provide increased impact resistance and/or increased puncture resistance while simultaneously facilitating good folding performance.

By providing a neutral stress configuration when the foldable substrate and/or the foldable apparatus is in a bent configuration, the force to bend the foldable apparatus to a predetermined parallel plate distance can be reduced. Further, providing a neutral stress configuration when the foldable apparatus is in a bent state can reduce the maximum stress and/or strain experienced by the foldable substrate and/or other components of the foldable apparatus during normal use conditions, which can, for example, enable increased durability and/or reduced fatigue of the foldable apparatus. In some embodiments, the neutral stress configuration can be generated by forming a ribbon (e.g., foldable substrate) at an elevated temperature (e.g., when the ribbon comprises a viscosity in a range from about 10⁴ Pascal-seconds and about 10⁷ Pascal-seconds and/or about an anneal point temperature) to form the foldable substrate.

Providing a lower fictive temperature (e.g., a fictive temperature substantially equal to the anneal point temperature) can increase the density of the foldable substrate (e.g., decreased molar volume, compaction) and can enable greater compressive stresses to be developed as a result of chemically strengthening the foldable substrate, for example, because the larger ions exchanged into the foldable substrate create larger stresses in a denser substrate because an average spacing between atoms is smaller in such substrates. Providing increased compressive stresses can enable durability and/or reduced fatigue of the foldable apparatus. Providing increased compressive stresses can enable the foldable substrate to better withstand bend-induced stresses, for example, countering tensile bend-induced stresses. Providing a compressive stress region can provide good impact resistance and/or good puncture resistance of the foldable substrate. For example, providing a foldable substrate comprising a first depth of compression and/or a second depth of compression in a range from about 1% to about 30% of the substrate thickness, good impact resistance, good puncture resistance, and/or good folding performance can be enabled. For example, providing a first maximum compressive stress and/or a second maximum compressive stress in a range from about 500 MPa to about 1,500 MPa, good impact resistance, good puncture resistance, and/or good folding performance can be enabled.

In some embodiments, the foldable apparatus can comprise a first housing member, a second housing member, and a support. Providing a support that contacts the central portion of the foldable substrate in a first configuration can reduce the incidence and/or extent of damage to the foldable substrate, for example by supporting the second major surface of the foldable substrate, which can enable good impact resistance and/or good puncture resistance of the foldable substrate. Providing an elastic modulus of the support that is less than an elastic modulus of the foldable substrate can help the foldable substrate withstand impacts, for example, by absorbing and dissipating some of the impact's energy while supporting the foldable substrate. Further, the support contacts the second major surface of the foldable substrate when the foldable apparatus is in a first configuration, which is when the foldable substrate is most vulnerable to impacts. In further embodiments, the first housing member, the second housing member, and the support can form a substantially continuous inner surface area, which can enable increased impact resistance and/or puncture resistance of the foldable substrate across the entire first major surface of the foldable substrate.

Providing a support that contacts the second major surface of the foldable substrate in the first configuration and is spaced from the second major surface of the foldable substrate can enable folding of the foldable apparatus into a compact configuration. For example, the foldable substrate can comprise a unitary support member that can enable a central portion of the foldable substrate positioned in a reception area to comprise a greater separation (e.g., first maximum spacing distance) than a second maximum spacing distance between the first portion of the foldable substrate and the second portion of the foldable substrate, which can facilitate folding the foldable apparatus into a compact configuration by providing a reception area to receive the central portion of the foldable substrate comprising the first maximum spacing distance. For example, providing a first support member and/or a second support member pivotably (e.g., pin-in-slot) attached to the first housing member and/or the second housing member can pivot to define a reception area in transitioning from the first configuration to the second configuration that can enable a compact second configuration of the foldable substrate. Further, the first housing member, second housing member, and support can protect the foldable substrate from damage in the second configuration.

Providing a coating can reduce folding-induced stresses of the foldable substrate. Providing a coating can reduce the force to achieve a small parallel plate distance (e.g., about 10 Newtons (N) or less to achieve a parallel plate distance of 10 mm, about 3 N or less to achieve a parallel plate distance of about 3 mm). Providing a coating can also improve the scratch resistance, the impact resistance, and/or the puncture resistance of the foldable apparatus while simultaneously facilitating good folding performance. The coating can enable low forces to achieve small parallel plate distances, for example, by shifting a neutral axis of the foldable substrate portion away from the coating (e.g., surface facing the user) when the coating has an elastic modulus less than an elastic modulus of a glass-based substrate and/or the coating has a thickness of about 200 μm or less. Further, providing a coating on the substrate can provide low energy fracture, for example, low-velocity ejection of shards upon failure of the foldable apparatus (e.g., when it is pushed beyond its design limits) and/or can comprise shards comprising an aspect ratio of about 3 or less.

Some example embodiments of the disclosure are described below with the understanding that any of the features of the various embodiments may be used alone or in combination with one another.

Embodiment 1. A foldable apparatus comprises a foldable substrate comprising a substrate thickness defined between a first major surface and a second major surface opposite the first major surface. The foldable substrate comprises a central portion positioned between a first portion and a second portion in a direction of a length of the foldable substrate. The foldable apparatus comprises a first housing member comprising a first inner surface area. A portion of the second major surface comprising the first portion of the foldable substrate faces an end portion of the first inner surface area. The end portion of the first inner surface area extends along a first plane. The foldable apparatus comprises a second housing member comprising a second inner surface area. A portion of the second major surface comprising the second portion of the foldable substrate faces an end portion of the second inner surface area. The end portion of the second inner surface area extending along a second plane. The foldable apparatus comprises a support attached to at least one of the first housing member or the second housing member. The support comprises a third inner surface area. The foldable apparatus is configured to be unfolded to a first configuration where a first angle between the first plane and the second plane is in a range from about 80° to about 135° and the third inner surface area of the support contacts the second major surface of the foldable substrate. The foldable apparatus is configured to be folded to a second configuration where a second angle between the first plane and the second plane is from about 0° to about 30° and the third inner surface area is spaced from the second major surface of the foldable substrate.

Embodiment 2. The foldable apparatus of embodiment 1, wherein the third inner surface area comprises a concave surface corresponding to a convex shape of the second major surface of the foldable substrate in the central portion.

Embodiment 3. The foldable apparatus of any one of embodiments 1-2, wherein substantially the entire second major surface of the foldable apparatus in the central portion is configured to be contacted by the support when the foldable apparatus is in the first configuration.

Embodiment 4. The foldable apparatus of any one of embodiments 1-3, wherein the first inner surface area, the third inner surface area, and the second inner surface area are configured to form a substantially continuous inner surface area when the foldable apparatus is in the first configuration.

Embodiment 5. The foldable apparatus of embodiment 4, wherein the substantially continuous inner surface area is configured to contact the second major surface of the foldable substrate across substantially the length of the foldable substrate when the foldable apparatus is in the first configuration.

Embodiment 6. The foldable apparatus of any one of embodiments 1-5, wherein the first housing member is pivotably attached to the second housing member.

Embodiment 7. The foldable apparatus of any one of embodiments 1-6, wherein the first portion of the foldable substrate is attached to the first housing member by a first adhesive. The second portion of the foldable substrate is attached to the second housing member by a second adhesive.

Embodiment 8. The foldable apparatus of embodiment 7, wherein the first adhesive comprises a first adhesive thickness in a range from about 5 micrometers to about 50 micrometers. The second adhesive comprises a second adhesive thickness in a range from about 5 micrometers to about 50 micrometers.

Embodiment 9. The foldable apparatus of any one of embodiments 1-8, wherein the support comprises an elastic modulus of about 1 GigaPascal or more at 23° C.

Embodiment 10. The foldable apparatus of embodiment 9, wherein the elastic modulus of the support is less than an elastic modulus of the foldable substrate at 23° C.

Embodiment 11. The foldable apparatus of any one of embodiments 1-10, wherein the foldable substrate comprises a width in a direction perpendicular to the length. The support is configured to contact substantially the entire width of the foldable substrate when the foldable apparatus is in the first configuration.

Embodiment 12. The foldable apparatus of any one of embodiments 1-11, wherein the support is integrally attached to the first housing member.

Embodiment 13. The foldable apparatus of embodiment 12, wherein the third inner surface area of the support and a fourth inner surface area of the second housing member are configured to define a reception area for receiving a folded portion of the foldable substrate when the foldable apparatus is in the second configuration.

Embodiment 14. The foldable apparatus of embodiment 13, wherein a first distance between the first plane and the second plane in a first direction is less than a maximum spacing distance in the first direction between a first location on the second major surface of the foldable substrate in the central portion and a second location on the second major surface of the foldable substrate in the central portion when the foldable apparatus is in the second configuration. The first location and the second location are positioned in the reception area when the foldable apparatus is in the second configuration.

Embodiment 15. The foldable apparatus of embodiment 14, wherein the first plane substantially impinges the first location when the foldable apparatus is in the second configuration.

Embodiment 16. The foldable apparatus of any one of embodiments 1-11, wherein the support comprises a first support and a second support. The first support is attached to the first housing member by a first pin-in-slot joint. The second support is attached to the second housing member by a second pin-in-slot joint.

Embodiment 17. The foldable apparatus of embodiment 16, wherein the first support comprises a first support surface area, the second support comprises a second support surface area. The third inner surface area comprises the first support surface area and the second support surface area. When the foldable apparatus is in the second configuration, a reception area is defined between the first inner surface area of the first support and the second inner surface area of the second support, and a portion of the foldable apparatus is positioned in the reception area.

Embodiment 18. The foldable apparatus of any one of embodiments 16-17, further comprising a platform comprising a platform surface facing the second major surface of the foldable substrate. The second support comprises a protrusion extending from an outer surface area opposite the second support surface area of the second support. The protrusion of the second housing member is configured to translate along the platform surface towards the second housing member when the foldable apparatus is folded from the first configuration to the second configuration.

Embodiment 19. The foldable apparatus of any one of embodiments 1-18, wherein the foldable substrate comprises a neutral stress configuration at a parallel plate distance in a range from about 20 millimeters to about 200 millimeters.

Embodiment 20. A foldable apparatus comprising a foldable substrate comprises a substrate thickness defined between a first major surface and a second major surface opposite the first major surface. The foldable substrate comprises a central portion positioned between a first portion and a second portion in a direction of a length of the foldable substrate. The foldable substrate comprises a neutral stress configuration at a parallel plate distance in a range from about 20 millimeters to about 200 millimeters.

Embodiment 21. The foldable apparatus of any one of embodiments 19-20, wherein the foldable substrate comprises the neutral stress configuration at a parallel plate distance in a range from about 40 millimeters to about 140 millimeters.

Embodiment 22. The foldable apparatus of any one of embodiments 1-21, wherein the foldable substrate comprises a fictive temperature substantially equal to an anneal point temperature of the foldable substrate.

Embodiment 23. The foldable apparatus of any one of embodiments 1-21, wherein the foldable substrate comprises a first compressive stress region extending to a first depth of compression from the first major surface. The foldable substrate comprises a second compressive stress region extending to a second depth of compression from the second major surface.

Embodiment 24. The foldable apparatus of embodiment 23, wherein the first depth of compression is in a range from about 15% to about 25% of the substrate thickness. The second depth of compression is in a range from about 15% to about 25% of the substrate thickness.

Embodiment 25. The foldable apparatus of any one of embodiments 23-24, wherein the first compressive stress region comprises a first maximum compressive stress in a range from about 500 MegaPascals to about 1,500 MegaPascals. The second compressive stress region comprises a second maximum compressive stress in a range from about 500 MegaPascals to about 1,500 MegaPascals.

Embodiment 26. The foldable apparatus of any one of embodiments 1-25, wherein the substrate thickness is in a range from about 25 micrometers to about 2 millimeters.

Embodiment 27. The foldable apparatus of any one of embodiments 1-26, wherein the foldable substrate is configured to achieve an effective bend radius of 5 millimeters.

Embodiment 28. The foldable apparatus of any one of embodiments 1-27, wherein the foldable substrate comprises a glass-based substrate.

Embodiment 29. The foldable apparatus of any one of embodiments 1-27, wherein the foldable substrate comprises a ceramic-based substrate.

Embodiment 30. A consumer electronic product comprises a housing comprising a front surface, a back surface, and side surfaces. The consumer electronic product comprises electrical components at least partially within the housing. The electrical components comprise a controller, a memory, and a display. The display is at or adjacent to the front surface of the housing. The consumer electronic product comprises a cover substrate disposed over the display. At least one of a portion of the housing or the cover substrate comprises the foldable apparatus of any one of embodiments 1-29.

Embodiment 31. A method of processing a foldable substrate comprises a substrate thickness defined between a first major surface and a second major surface opposite the first major surface. The method comprises heating the foldable substrate at about an anneal point temperature for a period of time from about 20 minutes to about 168 hours. The method comprises forming the foldable substrate into a non-planar configuration during the heating. The method comprises chemically strengthening the foldable substrate. The foldable substrate comprises a neutral stress configuration at a parallel plate distance in a range from about 20 millimeters to about 200 millimeters.

Embodiment 32. The method of embodiment 31, wherein the foldable substrate comprises the neutral stress configuration at a parallel plate distance in a range from about 40 millimeters to about 140 millimeters.

Embodiment 33. The method of any one of embodiments 31-32, wherein the period of time is equal to or greater than 30 times a ratio of a viscosity of the foldable substrate at the anneal point temperature to a shear modulus of the foldable substrate at 23° C.

Embodiment 34. The method of any one of embodiments 31-33, wherein after the chemically strengthening, the foldable substrate comprises a first compressive stress region extending to a first depth of compression from the first major surface. The foldable substrate comprises a second compressive stress region extending to a second depth of compression from the second major surface.

Embodiment 35. The method of embodiment 34, wherein the first depth of compression is in a range from about 15% to about 25% of the substrate thickness. The second depth of compression is in a range from about 15% to about 25% of the substrate thickness.

Embodiment 36. The method of any one of embodiments 34-35, wherein the first compressive stress region comprises a first maximum compressive stress in a range from about 500 MegaPascals to about 1,500 MegaPascals. The second compressive stress region comprises a second maximum compressive stress in a range from about 500 MegaPascals to about 1,500 MegaPascals.

Embodiment 37. The method of any one of embodiments 31-36, wherein forming the foldable substrate into a non-planar configuration during the heating comprises pressing the foldable substrate into a mold comprising a non-planar configuration.

Embodiment 38. The method of embodiment 37, wherein the mold corresponds to a parallel plate distance in a range from about 20 millimeters to about 200 millimeters.

Embodiment 39. The method of any one of embodiments 31-38, wherein the foldable substrate is configured to achieve an effective bend radius of 5 millimeters.

Embodiment 40. The method of any one of embodiments 31-39, wherein the foldable substrate comprises a glass-based substrate.

Embodiment 41. The method of any one of embodiments 31-39, wherein the foldable substrate comprises a ceramic-based substrate.

Embodiment 42. A method of making a foldable apparatus comprises the method of making a foldable substrate of any one of embodiments 31-41. The method comprises attaching the first portion of the foldable substrate to an end portion of a first inner surface area of a first housing member with a first adhesive. The end portion of the first housing member extends along a first plane. The method comprises attaching the second portion of the foldable substrate to an end portion of a second inner surface area of a second housing member with a second adhesive. The end portion of the second housing member extends along a second plane.

Embodiment 43. The method of embodiment 42, further comprising forming a hingable connection between the first housing member and the second housing member.

### BRIEF DESCRIPTION OF THE DRAWINGS

The above and other features and advantages of embodiments of the present disclosure are better understood when the following detailed description is read with reference to the accompanying drawings, in which:

FIG. 1 is a schematic view of an example foldable apparatus in an open configuration according to some embodiments, wherein a schematic view of a closed configuration may appear as shown in FIG. 4;

FIGS. 2-3 are cross-sectional views of the foldable apparatus along line 2-2 of FIG. 1 according to some embodiments;

FIG. 4 is a schematic view of example foldable apparatus of embodiments of the disclosure in a closed configuration, wherein a schematic view of the open configuration may appear as shown in FIG. 1;

FIGS. 5-6 are cross-sectional views of the foldable apparatus along line 5-5 of FIG. 4 according to some embodiments;

FIG. 7 schematically illustrates a foldable apparatus, resembling the foldable test apparatus of FIG. 8, in a neutral stress configuration;

FIG. 8 is a cross-sectional view of a testing apparatus to determine the effective minimum bend radius of an example foldable test apparatus;

FIG. 9 is a flow chart illustrating example methods making a foldable apparatus in accordance with embodiments of the disclosure;

FIGS. 10-11 schematically illustrate steps in methods of making a foldable apparatus; and

FIGS. 12-13 are plots illustrating experimental results for some embodiments of the disclosure.

Throughout the disclosure, the drawings are used to emphasize certain aspects. As such, it should not be assumed that the relative size of different regions, portions, and substrates shown in the drawings are proportional to its actual relative size, unless explicitly indicated otherwise.

### DETAILED DESCRIPTION

Embodiments will now be described more fully hereinafter with reference to the accompanying drawings in which example embodiments are shown. Whenever possible, the same reference numerals are used throughout the drawings to refer to the same or like parts. However, claims may encompass many different aspects of various embodiments and should not be construed as limited to the embodiments set forth herein.

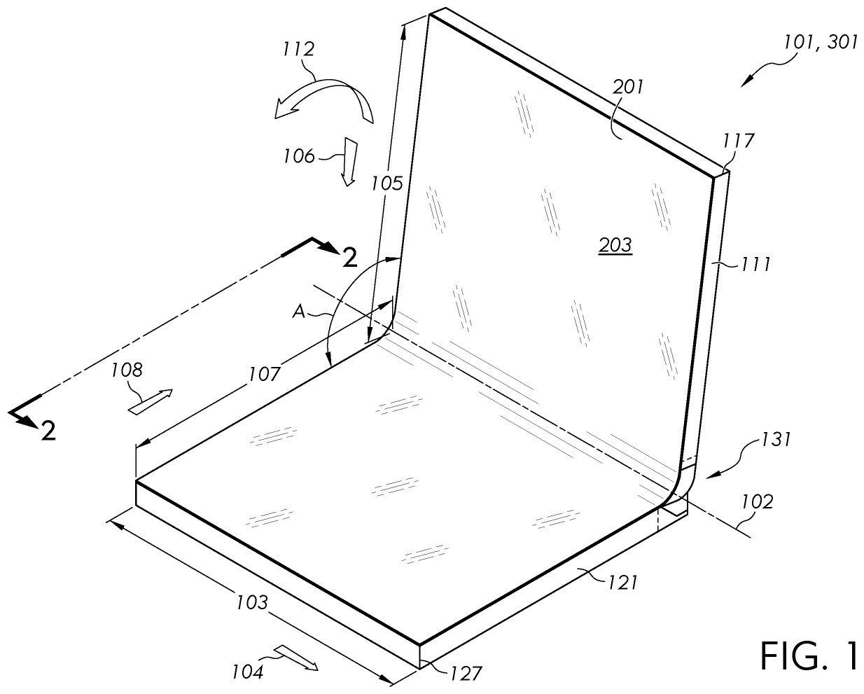

FIGS. 1-8 illustrate views of foldable apparatus 101, 301, 401, and 601 and/or the foldable test apparatus 701 in accordance with embodiments of the disclosure. Unless otherwise noted, a discussion of features of embodiments of one foldable apparatus can apply equally to corresponding features of any of the embodiments of the disclosure. For example, identical part numbers throughout the disclosure can indicate that, in some embodiments, the identified features are identical to one another and that the discussion of the identified feature of one embodiment, unless otherwise noted, can apply equally to the identified feature of any of the other embodiments of the disclosure.

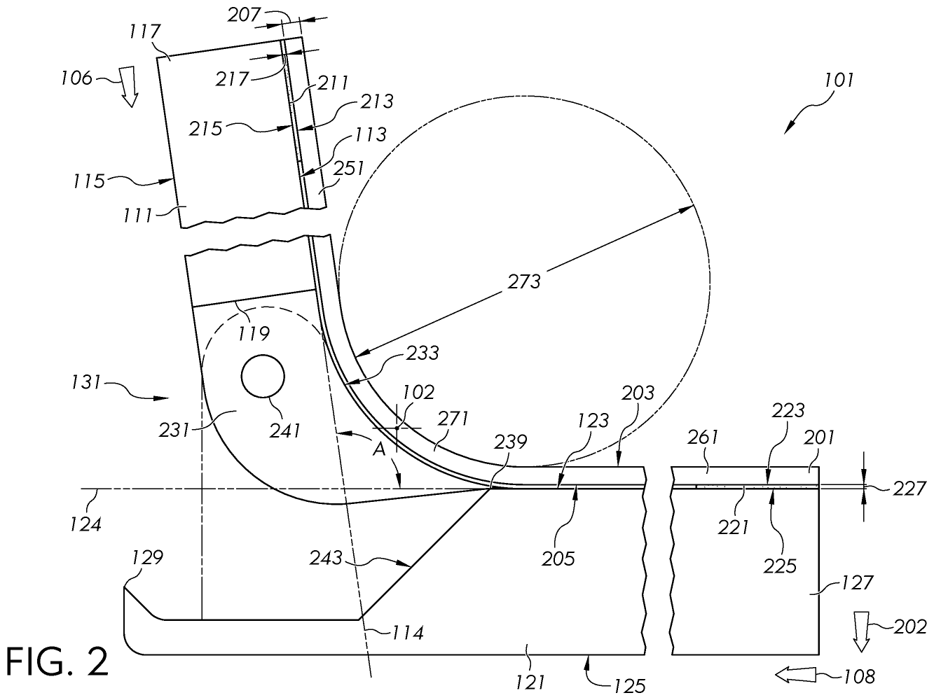

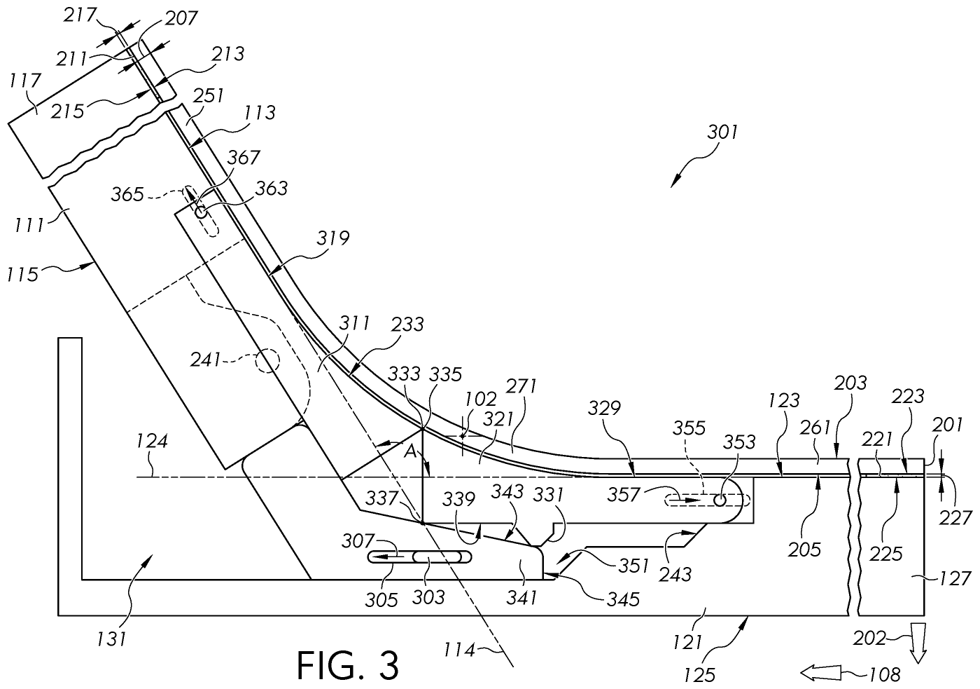

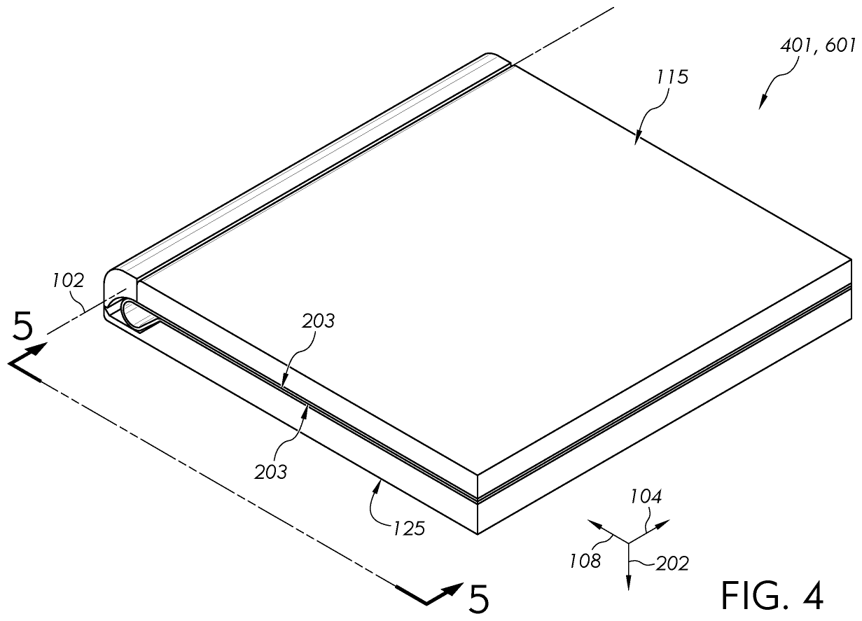

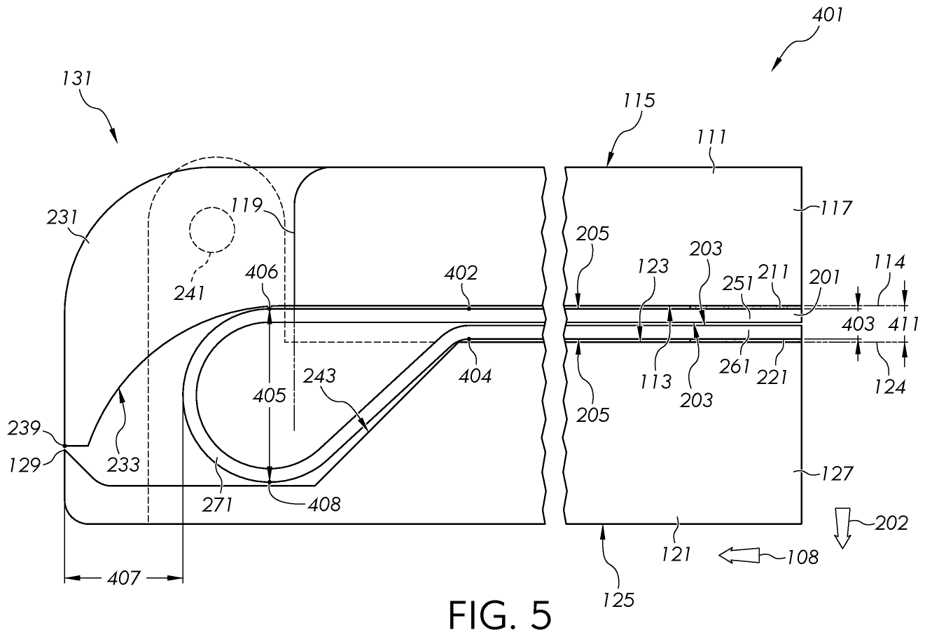

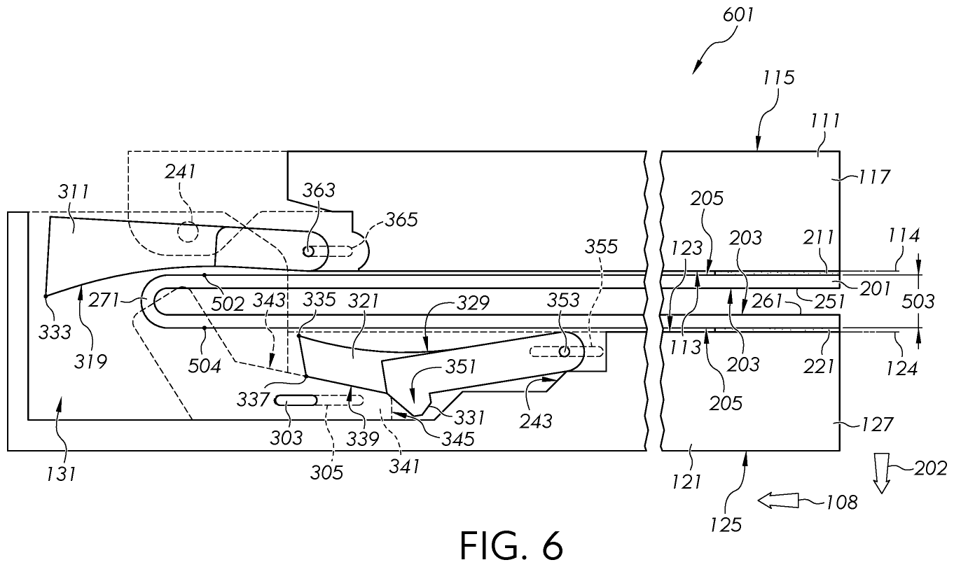

FIGS. 1-3 schematically illustrate example embodiments of foldable apparatus 101 and 301 in accordance with embodiments of the disclosure in a first (e.g., unfolded, bent, open) configuration while FIGS. 4-8 schematically illustrate example embodiments of foldable apparatus 401 and 601 and/or the foldable test apparatus 701 in accordance with embodiments of the disclosure in a second (e.g., folded, closed) configuration. As shown in FIGS. 1-3 and 5-8, the foldable apparatus 101, 301, 401, and 601 and/or the foldable test apparatus 701 can comprise a foldable substrate 201. In some embodiments, as shown in FIGS. 1-3 and 5-6, the foldable apparatus 101, 301, 401, and 601 can comprise a first housing member 111, a second housing member 121, and a support 131. The support 131 can be configured to contact the foldable substrate 201 in the unfolded configuration shown in FIGS. 2-3 while being spaced from the foldable substrate 201 in the folded configuration shown in FIGS. 5-6. In further embodiments, as shown in FIGS. 2 and 5, the support can comprise a unitary support member 231 attached to the first housing member 111. In further embodiments, as shown in FIGS. 3 and 6, the support 131 can comprise a first support member 311 and a second support member 321. In further embodiments, as shown in FIGS. 2-3 and 5-6, the foldable substrate 201 can be attached to the first housing member 111 by a first adhesive 211 and/or attached to the second housing member 121 by a second adhesive 221. In some embodiments, as shown in FIGS. 2-3 and 5-6, the first housing member 111 can be pivotably attached to the second housing member 121 by a pin 241, although other hingable connections can be provided in further embodiments.

Throughout the disclosure, with reference to FIG. 1, the width 103 of the foldable apparatus 101, 301, 401, and 601 and/or the foldable test apparatus 701 is considered the dimension of the foldable apparatus taken between opposed edges of the foldable apparatus in a direction 104 of a fold axis 102 of the foldable apparatus, wherein the direction 104 also comprises the direction of the width 103. Furthermore, throughout the disclosure, a first length 105 of the foldable apparatus is considered the dimension of the foldable apparatus taken between the fold axis 102 and an end portion 117 of the first housing member 111 in a direction 106 perpendicular to the fold axis 102 of the foldable apparatus. Throughout the disclosure, a second length 107 of the foldable apparatus is considered the dimension of the foldable apparatus taken between the fold axis 102 and an end portion 127 of the second housing member 121 in a direction 108 perpendicular to the fold axis 102 of the foldable apparatus. A total length of the foldable apparatus can be the sum of the first length 105 and the second length 107. A folded length of the foldable apparatus can be the greater of the first length 105 and the second length 107. In some embodiments, the first length 105 can be substantially equal to the second length 107, although in other embodiments the first length can be greater than or less than the second length. In some embodiments, the foldable apparatus can be folded in a direction 112 (e.g., see FIG. 1) about the fold axis 102 extending in the direction 104 of the width 103 to form a folded configuration (e.g., see FIGS. 4-6). As shown, the foldable apparatus may include a single fold axis to allow the foldable apparatus to comprise a bifold wherein, for example, the foldable apparatus may be folded in half. In further embodiments, the foldable apparatus may include two or more fold axes. For example, providing two fold axes can allow the foldable apparatus to comprise a trifold wherein, for example, the foldable apparatus may be folded with three portions comprising the first housing member 111, the second housing member 121, and a third portion similar or identical to the first housing member or the second housing member.

In some embodiments, the foldable substrate 201 can be optically transparent. As used herein, “optically transparent” or “optically clear” means an average transmittance of 70% or more in the wavelength range of 400 nm to 700 nm through a 1.0 mm thick piece of a material. In some embodiments, an “optically transparent material” or an “optically clear material” may have an average transmittance of 75% or more, 80% or more, 85% or more, or 90% or more, 92% or more, 94% or more, 96% or more in the wavelength range from 400 nm to 700 nm through a 1.0 mm thick piece of the material. The average transmittance in the wavelength range of 400 nm to 700 nm is calculated by averaging transmittance measurements at whole number wavelengths from about 400 nm to about 700 nm.

In some embodiments, the foldable substrate 201 can comprise a glass-based portion. As used herein, “glass-based” includes both glasses and glass-ceramics, wherein glass-ceramics have one or more crystalline phases and an amorphous, residual glass phase. Glass-based material can cool or has already cooled into a glass, glass-ceramic, and/or that upon further processing becomes a glass-ceramic material. A glass-based material (e.g., glass-based substrate) may comprise an amorphous material (e.g., glass) and optionally one or more crystalline materials (e.g., ceramic). Amorphous materials and glass-based materials may be strengthened. As used herein, the term “strengthened” may refer to a material that has been chemically strengthened, for example, through ion-exchange of larger ions for smaller ions in the surface of the substrate, as discussed below. However, other strengthening methods, for example, thermal tempering, or utilizing a mismatch of the coefficient of thermal expansion between portions of the substrate to create compressive stress and central tension regions, may be utilized to form strengthened substrates. Exemplary glass-based materials, which may be free of lithia or not, comprise soda lime glass, alkali aluminosilicate glass, alkali-containing borosilicate glass, alkali-containing aluminoborosilicate glass, alkali-containing phosphosilicate glass, and alkali-containing aluminophosphosilicate glass. In one or more embodiments, a glass-based material may comprise, in mole percent (mol %): SiO2 in a range from about 40 mol % to about 80%, Al₂O₃ in a range from about 10 mol % to about 30 mol %, B₂O₃ in a range from 0 mol % to about 10 mol %, ZrO₂ in a range from 0 mol % to about 5 mol %, P₂O₅ in a range from 0 mol % to about 15 mol %, TiO₂ in a range from 0 mol % to about 2 mol %, R₂O in a range from 0 mol % to about 20 mol %, and RO in a range from 0 mol % to about 15 mol %. As used herein, R₂O can refer to an alkali metal oxide, for example, Li₂O, Na₂O, K₂O, Rb₂O, Cs₂O, or combinations thereof. As used herein, RO can refer to MgO, CaO, SrO, BaO, ZnO, or combinations thereof. In some embodiments, a glass-based substrate may optionally further comprise in a range from 0 mol % to about 2 mol % of each of Na₂SO₄, NaCl, NaF, NaBr, K₂SO₄, KCl, KF, KBr, As₂O₃, Sb₂O₃, SnO₂, Fe₂O₃, MnO, MnO₂, MnO₃, Mn₂O₃, Mn₃O₄, and/or Mn₂O₇. “Glass-ceramics” include materials produced through controlled crystallization of glass. In some embodiments, glass-ceramics can comprise about 1% to about 99% crystallinity. Examples of suitable glass-ceramics may include Li₂O—Al₂O₃—SiO₂ system (i.e., LAS-System) glass-ceramics, MgO—Al₂O₃—SiO₂ system (i.e., MAS-System) glass-ceramics, ZnO×Al₂O₃×nSiO₂ (i.e., ZAS system), and/or glass-ceramics that include a predominant crystal phase including 0-quartz solid solution, β-spodumene, cordierite, petalite, and/or lithium disilicate. Glass-ceramic substrates may be strengthened using strengthening processes described herein. In one or more embodiments, MAS-System glass-ceramic substrates may be strengthened in Li₂SO₄ molten salt, whereby an exchange of 2Li⁺ for Mg²⁺ can occur.

In some embodiments, the foldable substrate 201 can comprise a glass-based portion and/or a ceramic-based portion having a pencil hardness of 8H or more, for example, 9H or more. As used herein, pencil hardness is measured using ASTM D 3363-20 with standard lead graded pencils. In some embodiments, the foldable substrate 201 can comprise a ceramic-based portion, which may or may not be strengthened. As used herein, “ceramic-based” includes both ceramics and glass-ceramics, wherein glass-ceramics have one or more crystalline phases and an amorphous, residual glass phase. In some embodiments, a ceramic-based material can be formed by heating a glass-based material to form ceramic (e.g., crystalline) portions. In further embodiments, ceramic-based materials may comprise one or more nucleating agents that can facilitate the formation of crystalline phase(s). In some embodiments, the ceramic-based materials can comprise one or more oxides, nitrides, oxynitrides, carbides, borides, and/or silicides. Example embodiments of ceramic oxides include zirconia (ZrO₂), zircon (ZrSiO₄), an alkali metal oxide (e.g., sodium oxide (Na₂O)), an alkali earth metal oxide (e.g., magnesium oxide (MgO)), titania (TiO₂), hafnium oxide (Hf₂O), yttrium oxide (Y₂O₃), iron oxides, beryllium oxides, vanadium oxide (VO₂), fused quartz, mullite (a mineral comprising a combination of aluminum oxide and silicon dioxide), and spinel (MgAl₂O₄). Example embodiments of ceramic nitrides include silicon nitride (Si₃N₄), aluminum nitride (AlN), gallium nitride (GaN), beryllium nitride (Be₃N₂), boron nitride (BN), tungsten nitride (WN), vanadium nitride, alkali earth metal nitrides (e.g., magnesium nitride (Mg₃N₂)), nickel nitride, and tantalum nitride. Example embodiments of oxynitride ceramics include silicon oxynitride, aluminum oxynitride, and a SiAlON (a combination of alumina and silicon nitride and can have a chemical formula, for example, Si₁₂₋ₘ₋ₙAlₘ₊ₙOₙN₁₆₋ₙ, Si₆₋ₙAlₙOₙN₈₋ₙ, or Si₂₋ₙAlₙO₁₊ₙN₂₋ₙ, where m, n, and the resulting subscripts are all non-negative integers). Example embodiments of carbides and carbon-containing ceramics include silicon carbide (SiC), tungsten carbide (WC), an iron carbide, boron carbide (B₄C), alkali metal carbides (e.g., lithium carbide (Li₄C₃)), alkali earth metal carbides (e.g., magnesium carbide (Mg₂C₃)), and graphite. Example embodiments of borides include chromium boride (CrB₂), molybdenum boride (Mo₂B₅), tungsten boride (W₂B₅), iron boride, titanium boride, zirconium boride (ZrB₂), hafnium boride (HfB₂), vanadium boride (VB₂), Niobium boride (NbB₂), and lanthanum boride (LaB₆). Example embodiments of silicides include molybdenum disilicide (MoSi₂), tungsten disilicide (WSi₂), titanium disilicide (TiSi₂), nickel silicide (NiSi), alkali earth silicide (e.g., sodium silicide (NaSi)), alkali metal silicide (e.g., magnesium silicide (Mg₂Si)), hafnium disilicide (HfSi₂), and platinum silicide (PtSi).

In some embodiments, the foldable substrate 201 can comprise a first polymer-based portion. The first polymer-based portion can comprise a rigid polymer (e.g., comprising an elastic modulus at 25° C. of about 3 GigaPascals (GPa) or more, about 8 GPa or more, about 9 GPa or more, or about 10 GPa or more). Example embodiments of rigid polymers include but are not limited to blends, nanoparticle, and/or fiber composites of one or more of styrene-based polymers (e.g., polystyrene (PS), styrene acrylonitrile (SAN), styrene maleic anhydride (SMA)), phenylene-based polymers (e.g., polyphenylene sulfide (PPS)), polyvinylchloride (PVC), polysulfone (PSU), polyphthalmide (PPA), polyoxymethylene (POM), polylactide (PLA), polyimides (PI), polyhydroxybutyrate (PHB), polyglycolides (PGA), polyethyleneterephthalate (PET), and/or polycarbonate (PC).

Throughout the disclosure, a tensile strength, ultimate elongation (e.g., strain at failure), and yield point of a polymeric material (e.g., adhesive, polymer-based portion) is determined using ASTM D638 using a tensile testing machine, for example, an Instron 3400 or Instron 6800, at 25° C. and 50% relative humidity with a type I dogbone shaped sample. Throughout the disclosure, an elastic modulus (e.g., Young's modulus) and/or a Poisson's ratio is measured using ISO 527-1:2019. In some embodiments, the foldable substrate 201 can comprise an elastic modulus of about 1 GigaPascal (GPa) or more, about 3 GPa or more, about 5 GPa or more, about 10 GPa or more, about 100 GPa or less, about 80 GPa or less, about 60 GPa or less, or about 20 GPa or less. In some embodiments, the foldable substrate 201 can comprise an elastic modulus in a range from about 1 GPa to about 100 GPa, from about 1 GPa to about 80 GPa, from about 3 GPa to about 80 GPa, from about 3 GPa to about 60 GPa, from about 5 GPa to about 60 GPa, from about 5 GPa to about 20 GPa, from about 10 GPa to about 20 GPa, or any range or subrange therebetween. In further embodiments, the foldable substrate 201 can comprise a glass-based portion or a ceramic-based portion comprising an elastic modulus in a range from about 10 GPa to about 100 GPa, from about 40 GPa to about 100 GPa, from about 60 GPa to about 100 GPa, from about 60 GPa to about 80 GPa, from about 80 GPa to about 100 GPa, or any range or subrange therebetween. In some embodiments, the foldable substrate 201 can comprise a polymer-based portion comprising an elastic modulus in a range from about 1 GPa to about 18 GPa, from about 3 GPa to about 18 GPa, from about 3 GPa to about 10 GPa, from about 5 GPa to about 10 GPa, from about 3 GPa to about 5 GPa, from about 1 GPa to about 10 GPa, from about 1 GPa to about 5 GPa, from about 1 GPa to about 3 GPa, or any range or subrange therebetween.

As shown in FIGS. 2-3 and 5-8, the foldable substrate 201 can comprise a first major surface 203 and a second major surface 205 opposite the first major surface 203. The foldable substrate 201 will now be described with reference to the foldable substrate 201 of the foldable apparatus 101 shown in FIG. 2 with the understanding that such description of the foldable substrate 201, unless otherwise stated, can also apply to any embodiments of the disclosure, for example, in the foldable apparatus 301, 401, and 601 and/or the foldable test apparatus 701 illustrated in FIGS. 3 and 5-8. In further embodiments, as shown, the first major surface 203 can be parallel to the second major surface 205. A substrate thickness 207 can be defined between the first major surface 203 and the second major surface 205. In some embodiments, the substrate thickness 207 can be substantially uniform across the first major surface 203. In some embodiments, the substrate thickness 207 can be about 10 micrometers (μm) or more, about 25 μm or more, about 30 μm or more, about 50 μm or more, 80 μm or more, about 100 μm or more, about 125 μm or more, about 2 millimeters (mm) or less, about 500 μm or less, about 400 μm or less, about 200 μm or less, or about 125 μm or less. In some embodiments, the substrate thickness 207 can be in a range from about 10 μm to about 2 mm, from about 25 μm to about 2 mm, from about 30 μm to about 2 mm, from about 50 μm to about 2 mm, from about 80 μm to about 2 mm, from about 125 μm to about 2 mm, from about 10 μm to about 500 μm, from about 25 μm to about 500 μm, from about 30 μm to about 500 μm, from about 50 μm to about 500 μm, from about 80 μm to about 500 μm, from about 80 μm to about 400 μm, from about 80 μm to about 200 μm, from about 80 μm to about 125 μm, from about 100 μm to about 500 μm, from about 100 μm to about 400 μm, from about 100 μm to about 200 μm, from about 100 μm to about 125 μm, from about 125 μm to about 500 μm, from about 125 μm to about 400 μm, from about 125 μm to about 200 μm, or any range or subrange therebetween. In some embodiments, the substrate thickness 207 can be in a range from about 10 μm to about 200 μm, from about 25 μm to about 200 μm, from about 25 μm to about 125 μm, from about 25 μm to about 60 μm, from about 25 μm to about 50 μm, from about 30 μm to about 200 μm, from about 30 μm to about 125 μm, from about 30 μm to about 50 μm, or any range or subrange therebetween. In some embodiments, the substrate thickness 207 may be substantially uniform between the first major surface 203 and the second major surface 205 across its corresponding length (i.e., in the direction 106 of the length (e.g., first length 105, second length 107) of the foldable apparatus) and/or its corresponding width (i.e., in the direction 104 of the width 103 of the foldable apparatus).

As used herein, if a first layer and/or component is described as “disposed over” a second layer and/or component, other layers may or may not be present between the first layer and/or component and the second layer and/or component. Furthermore, as used herein, “disposed over” does not refer to a relative position with reference to gravity. For example, a first layer and/or component can be considered “disposed over” a second layer and/or component, for example, when the first layer and/or component is positioned underneath, above, or to one side of a second layer and/or component. As used herein, a first layer and/or component described as “bonded to” a second layer and/or component means that the layers and/or components are bonded to each other, either by direct contact and/or bonding between the two layers and/or components or via an adhesive layer.

As shown in FIGS. 2-3 and 5-6, the foldable substrate 201 can comprise a first portion 251, a second portion 261, and a central portion 271. In some embodiments, the first major surface 203 and/or second major surface 205 in the first portion 251 can comprise a substantially planar surface (e.g., diameter of curvature greater than about 500 mm or greater than about 1,000 mm). In further embodiments, the first major surface 203 and/or second major surface 205 in the first portion 251 can be parallel to the first plane 114 that a first inner surface area 113 of the first housing member 111 extends along. In further embodiments, as shown, the first portion 251 can be disposed over the first housing member 111. In even further embodiments, the first portion 251 can extend from the end portion 117 of the first housing member 111 to the central portion 271 of the foldable substrate 201. In some embodiments, the first major surface 203 and/or second major surface 205 in the second portion 261 can comprise a substantially planar surface (e.g., diameter of curvature greater than about 500 mm or greater than about 1,000 mm). In further embodiments, the first major surface 203 and/or second major surface 205 in the second portion 261 can be parallel to the second plane 124 that a second inner surface area 123 of the second housing member 121 extends along. In further embodiments, as shown, the second portion 261 can be disposed over the second housing member 121. In even further embodiments, the second portion 261 can extend from the end portion 127 of the second housing member 121 to the central portion 271 of the foldable substrate 201. It is to be understood that attributes of the first portion, first housing member, and/or first adhesive layer can be switched, interchanged, the same as, or replaced with the corresponding attributes of the second portion, second housing member, and/or second adhesive layer, and vice versa.

As shown in FIGS. 2-3 and 5-6, the central portion 271 can be positioned between the first portion 251 and the second portion 261. In some embodiments, as shown in FIG. 2, the first major surface 203 of the central portion 271 can comprise a diameter of curvature 273 (e.g., twice a radius of curvature) in the first configuration. In further embodiments, the diameter of curvature 273 of the first major surface 203 in the central portion 271 can be about 2 mm or more, about 5 mm or more, about 10 mm or more, about 20 mm or more, about 100 mm or less, about 80 mm or less, about 60 mm or less, about 40 mm or less, or about 30 mm or less. In further embodiments, the diameter of curvature 273 of the first major surface 203 in the central portion 271 can be in a range from about 2 mm to about 100 mm, from about 2 mm to about 80 mm, from about 5 mm to about 80 mm, from about 5 mm to about 60 mm, from about 10 mm to about 60 mm, from about 10 mm to about 40 mm, from about 20 mm to about 40 mm, from about 20 mm to about 30 mm, or any range or subrange therebetween. In some embodiments, as shown in FIGS. 2-3, the first major surface 203 in the central portion 271 can comprise a concave surface in the first configuration. In further embodiments, as shown in FIGS. 2-3, the second major surface 205 in the central portion 271 can comprise a convex surface in the first configuration. As discussed herein, the central portion 271 can be supported by the support 131 in the first configuration. In some embodiments, as shown in FIGS. 2-3, the support 131 (e.g., third inner surface area 233, first support surface area 319, second support surface area 329) can contact the second major surface 205 of the foldable substrate 201.

As shown in FIGS. 2-3 and 5-6, the foldable apparatus 101, 301, 401, and 601 can comprise the first adhesive 211 comprising a first contact surface 213 and a second contact surface 215 opposite the first contact surface 213. In some embodiments, as shown, the first contact surface 213 of the first adhesive 211 can comprise a planar surface. In some embodiments, as shown, the second contact surface 215 of the first adhesive 211 can comprise a planar surface. In some embodiments, as shown, the first contact surface 213 of the first adhesive 211 can face the second major surface 205 of the foldable substrate 201 in the first portion 251. In further embodiments, as shown, the first contact surface 213 of the first adhesive 211 can contact the second major surface 205 of the foldable substrate 201 in the first portion 251. In further embodiments, as shown, the first adhesive 211 can attach the first portion 251 of the foldable substrate 201 to the first housing member 111. In even further embodiments, as shown, the first adhesive 211 can attach the first portion 251 of the foldable substrate 201 to the end portion 117 of the first housing member 111. In some embodiments, although not shown, the first adhesive 211 can extend between a first inner surface area 113 of the first housing member 111 and the second major surface 205 of the foldable substrate 201 in the first portion 251 for substantially the entire length of the first inner surface area 113 and/or the first portion 251. In some embodiments, although not shown, the first adhesive 211 can be omitted, for example, when the foldable substrate 201 is attached to the first housing member 111 by other means (e.g., framing). A first adhesive thickness 217 of the first adhesive 211 can be defined between the first contact surface 213 and the second contact surface 215. In some embodiments, the first adhesive thickness 217 of the first adhesive 211 can be about 1 μm or more, about 5 μm or more, about 10 μm or more, about 100 μm or less, about 60 μm or less, about 50 μm or less, about 30 μm or less, or about 20 μm or less. In some embodiments, the first adhesive thickness 217 of the first adhesive 211 can be in a range from about 1 μm to about 100 μm, from about 5 μm to about 100 μm, from about 5 μm to about 60 μm, from about 5 μm to about 50 μm, from about 10 μm to about 50 μm, from about 10 μm to about 30 μm, from about 10 μm to about 20 μm, or any range or subrange therebetween. In some embodiments, the first adhesive thickness 217 of the first adhesive 211 can in a range from about 5 μm to about 30 μm, from about 5 μm to about 20 μm, or any range or subrange therebetween.

As shown in FIGS. 2-3 and 5-6, the foldable apparatus 101, 301, 401, and 601 can comprise the second adhesive 221 comprising a third contact surface 223 and a fourth contact surface 225 opposite the third contact surface 223. In some embodiments, as shown, the third contact surface 223 of the second adhesive 221 can comprise a planar surface. In some embodiments, as shown, the fourth contact surface 225 of the second adhesive 221 can comprise a planar surface. In some embodiments, as shown, the third contact surface 223 of the second adhesive 221 can face the second major surface 205 of the foldable substrate 201 in the second portion 261. In further embodiments, as shown, the third contact surface 223 of the second adhesive 221 can contact the second major surface 205 of the foldable substrate 201 in the second portion 261. In further embodiments, as shown, the second adhesive 221 can attach the second portion 261 of the foldable substrate 201 to the second housing member 121. In still further embodiments, as shown, the second adhesive 221 can attach the second portion 261 of the foldable substrate 201 to the end portion 127 of the second housing member 121. In some embodiments, although not shown, the second adhesive 221 can extend between a second inner surface area 123 of the second housing member 121 and the second major surface 205 of the foldable substrate 201 in the second portion 261 for substantially the entire length of the second inner surface area 123 and/or the second portion 261. In some embodiments, although not shown, the second adhesive 221 can be omitted, for example, when the foldable substrate 201 is attached to the second housing member 121 by other means (e.g., framing). A second adhesive thickness 227 of the second adhesive 221 can be defined between the third contact surface 223 and the fourth contact surface 225. In some embodiments, the second adhesive thickness 227 of the second adhesive 221 can be within one or more of the ranges discussed above for the first adhesive thickness 217 (e.g., from about 5 μm to about 50 μm).

In some embodiments, the first adhesive 211 and/or the second adhesive 221 can be optically transparent. In some embodiments, the first adhesive 211 and/or the second adhesive 221 can comprise one or more of a polyolefin, a polyamide, a halide-containing polymer (e.g., polyvinylchloride or a fluorine-containing polymer), an elastomer, a urethane, phenolic resin, parylene, polyethylene terephthalate (PET), and/or polyether ether ketone (PEEK). Example embodiments of polyolefins include low molecular weight polyethylene (LDPE), high molecular weight polyethylene (HDPE), ultrahigh molecular weight polyethylene (UHMWPE), and polypropylene (PP). Example embodiments of fluorine-containing polymers include polytetrafluoroethylene (PTFE), polyvinylfluoride (PVF), polyvinylidene fluoride (PVDF), perfluoropolyether (PFPE), perfluorosulfonic acid (PFSA), a perfluoroalkoxy (PFA), fluorinated ethylene propylene (FEP) polymers, and ethylene tetrafluoro ethylene (ETFE) polymers. Example embodiments of elastomers include rubbers (e.g., polybutadiene, polyisoprene, chloroprene rubber, butyl rubber, nitrile rubber) and block copolymers (e.g., styrene-butadiene, high-impact polystyrene, poly(dichlorophosphazene). In further embodiments, the first adhesive 211 and/or the second adhesive 221 can comprise an optically clear adhesive. In further embodiments, the first adhesive 211 and/or the second adhesive 221 can comprise an optically clear adhesive. In even further embodiments, the optically clear adhesive can comprise one or more optically transparent polymers: an acrylic (e.g., polymethylmethacrylate (PMMA)), an epoxy, silicone, and/or a polyurethane. Examples of epoxies include bisphenol-based epoxy resins, novolac-based epoxies, cycloaliphatic-based epoxies, and glycidylamine-based epoxies. In even further embodiments, the optically clear adhesive can comprise, but is not limited to, acrylic adhesives, for example, 3M 8212 adhesive, or an optically transparent liquid adhesive, for example, a LOCTITE optically transparent liquid adhesive. Exemplary embodiments of optically clear adhesives comprise transparent acrylics, epoxies, silicones, and polyurethanes. For example, the optically transparent liquid adhesive could comprise one or more of LOCTITE AD 8650, LOCTITE AA 3922, LOCTITE EA E-05MR, LOCTITE UK U-09LV, which are all available from Henkel. In some embodiments, the first adhesive 211 can comprise a composition that is the same as a composition of the second adhesive 221.

Throughout the disclosure, a tensile strength, ultimate elongation (e.g., strain at failure), and yield point of a polymeric material (e.g., first adhesive, second adhesive) is determined using ASTM D638 using a tensile testing machine, for example, an Instron 3400 or Instron 6800, at 25° C. and 50% relative humidity with a type I dogbone shaped sample. Throughout the disclosure, an elastic modulus (e.g., Young's modulus) and/or a Poisson's ratio is measured using ISO 527-1:2019. In some embodiments, the first adhesive 211 and/or the second adhesive 221 can comprise an elastic modulus of about 0.01 MegaPascals (MPa) or more, about 1 MPa or more, about 10 MPa or more, about 20 MPa or more, about 100 MPa or more, about 10,000 MPa or less, about 3,000 MPa or less, about 1,000 MPa or less, about 500 MPa or less, or about 300 MPa or less. In some embodiments, the first adhesive 211 and/or the second adhesive 221 can comprise an elastic modulus in a range from about 0.01 MPa to about 10,000 MPa, from about 0.01 MPa to about 3,000 MPa, from about 1 MPa to about 3,000 MPa, from about 10 MPa to about 3,000 MPa, from about 20 MPa to about 3,000 MPa, from about 20 MPa to about 1,000 MPa, from about 20 MPa to about 300 MPa, from about 100 MPa to about 300 MPa, from about 200 MPa to about 300 MPa, or any range or subrange therebetween. In some embodiments, the elastic modulus of the first adhesive 211 and/or the second adhesive 221 can be in a range from about 0.01 MPa to about 1,000 MPa, from about 0.01 MPa to about 500 MPa, from about 0.01 MPa to about 300 MPa, from about 1 MPa to about 300 MPa, from about 10 MPa to about 300 MPa, or any range or subrange therebetween. In some embodiments, the elastic modulus of the first adhesive 211 and/or the second adhesive 221 can be in a range from about 1 GPa to about 20 GPa, from about 1 GPa to about 18 GPa, from about 1 GPa to about 10 GPa, from about 1 GPa to about 5 GPa, from about 1 GPa to about 3 GPa, or any range or subrange therebetween. In some embodiments, the elastic modulus of the first adhesive 211 and/or the second adhesive 221 can be in a range from about 0.001 MPa to about 50 MPa, from about 0.01 MPa to about 50 MPa, from about 0.01 MPa to about 20 MPa, from about 0.05 MPa to about 20 MPa, from about 0.05 MPa to about 10 MPa, from about 0.1 MPa to about 5 MPa, from about 0.5 MPa to about 5 MPa, from about 1 MPa to about 5 MPa, from about 0.001 MPa to about 0.5 MPa, from about 0.01 MPa to about 0.5 MPa, from about 0.01 MPa to about 0.1 MPa, from about 0.05 MPa to about 0.1 MPa, or any range or subrange therebetween.

As used herein, a material exhibits linear elasticity to a predetermined strain if the relationship between stress and strain going from 0 strain to the predetermined strain is substantially linear. In some embodiments, the first adhesive 211 and/or the second adhesive 221 can comprise linear elasticity to a strain of about 5% or more, about 8% or more, about 10% or more, about 12% or more, about 15% or more, about 18% or more, about 20% or more, about 22% or more, about 25% or more, about 30% or more, or about 50% or more. In some embodiments, the first adhesive 211 and/or the second adhesive 221 can remain within an elastic deformation regime under nominal use conditions (e.g., folding of the foldable apparatus comprising the corresponding adhesive layer(s) to a parallel plate distance of at least 10 mm, 5 mm, 3 mm, etc.). As used herein, an elastic deformation regime includes the range of the deformations that a material can recover 99% of its original dimension after being deformed to that deformation (e.g., a strain set of about 1% or less). Without wishing to be bound by theory, a first material may remain within its elastic deformation regime when the tensile strength of the first material is less than the product of the first material's elastic modulus and the first material's thickness divided by twice the effective minimum bend radius of the foldable apparatus when the thickness of the first material divided by the effective minimum bend radius of the foldable apparatus is less than the first material's yield strain. As used herein, a tensile strength is a stress on the material at yield. For example, a first material would be within its elastic deformation regime if it is in a foldable apparatus comprising an effective minimum bend radius of 1 mm as the thickness of the first material is 100 μm as long as the yield strain of the first material is 0.1 and the tensile strength of the first material is more than 10 times the elastic modulus of the first material. In some embodiments, the first adhesive 211 and/or the second adhesive 221 can comprise a strain at yield of about 5% or more, about 8% or more, about 10% or more, about 12% or more, or about 20% or more. In some embodiments, the first adhesive 211 and/or the second adhesive 221 can comprise a strain at yield in a range from about 5% to about 10,000%, from about 5% to about 5,000%, from about 8% to about 1,000%, from about 8% to about 500%, from about 10% to about 300%, from about 10% to about 100%, from about 12% to about 100%, from about 20% to about 100%, from about 20% to about 50%, or any range or subrange therebetween. As discussed below, curing the material in a bent configuration can reduce the effective maximum strain on the first material as the foldable apparatus is folded between unfolded and folded configurations, which can allow more materials to be used while still keeping the first material within its elastic deformation regime.

As shown in FIGS. 1-3 and 5-6, the foldable apparatus 101, 301, 401, and 601 can comprise the first housing member 111 that the foldable substrate 201 can be disposed over. The first housing member 111 will now be described with reference to the foldable apparatus 101 of FIG. 2 with the understanding that such description of the first housing member 111, unless otherwise stated, can also apply to any embodiments of the disclosure, for example, the foldable apparatus 301, 401, and 601 illustrated in FIGS. 3 and 5-6. As shown in FIG. 2, the first housing member 111 can comprise the first inner surface area 113 and a first outer surface area 115 opposite the first inner surface area 113. As shown, the first housing member 111 can comprise the end portion 117 that can be opposite the fold axis 102. In some embodiments, as shown in FIG. 2, the end portion 117 of the first inner surface area 113 can extend along the first plane 114. In further embodiments, as shown, substantially the entire first inner surface area 113 can extend along the first plane 114. In some embodiments, as shown, a portion (e.g., first portion 251) of the second major surface 205 of the foldable substrate 201 can face the end portion 117 of the first inner surface area 113 of the first housing member 111. In further embodiments, the first portion 251 of the second major surface 205 of the foldable substrate 201 can face the first inner surface area 113 of the first housing member 111. In further embodiments, the first portion 251 of the second major surface 205 of the foldable substrate 201 can be attached to the first inner surface area 113 of the first housing member 111, for example, through the first adhesive 211, although other means can be provided in other embodiments. In some embodiments, the second contact surface 215 of the first adhesive 211 can face the first inner surface area 113 of the first housing member 111. In further embodiments, the second contact surface 215 of the first adhesive 211 can contact the first inner surface area 113 (e.g., the end portion 117).

As shown in FIGS. 1-3 and 5-6, the foldable apparatus 101, 301, 401, and 601 can comprise the second housing member 121 that the foldable substrate 201 can be disposed over. The second housing member 121 will now be described with reference to the foldable apparatus 101 of FIG. 2 with the understanding that such description of the second housing member 121, unless otherwise stated, can also apply to any embodiments of the disclosure, for example, the foldable apparatus 301, 401, and 601 illustrated in FIGS. 3 and 5-6. As shown in FIG. 2, the second housing member 121 can comprise the second inner surface area 123 and a second outer surface area 125 opposite the second inner surface area 123. As shown, the second housing member 121 can comprise the end portion 127 that can be opposite the fold axis 102. In some embodiments, as shown in FIG. 2, the end portion 127 of the second inner surface area 123 can extend along the second plane 124. In further embodiments, as shown, substantially the entire second inner surface area 123 can extend along the second plane 124. In some embodiments, as shown, a portion (e.g., second portion 261) of the second major surface 205 of the foldable substrate 201 can face the end portion 127 of the second inner surface area 123 of the second housing member 121. In further embodiments, the second portion 261 of the second major surface 205 of the foldable substrate 201 can face the second inner surface area 123 of the second housing member 121. In further embodiments, the second portion 261 of the second major surface 205 of the foldable substrate 201 can be attached to the second inner surface area 123 of the second housing member 121, for example, through the second adhesive 221, although other means can be provided in other embodiments. In some embodiments, the fourth contact surface 225 of the second adhesive 221 can face the second inner surface area 123 of the second housing member 121. In further embodiments, the fourth contact surface 225 of the second adhesive 221 can contact the second inner surface area 123 (e.g., the end portion 117).

In some embodiments, as shown, the second housing member 121 can further comprise a fourth inner surface area 243. In further embodiments, as shown, the fourth inner surface area 243 can deviate from the second plane 124, for example, comprising an inclined surface relative to the second plane 124. In even further embodiments, the fourth inner surface area 243 can comprise one or more an inclined surface, a curved surface, a flat surface (e.g., substantially parallel to the second plane 124), a vertical surface (e.g., substantially perpendicular to the second plane 124), or combinations thereof. For example, as shown in FIGS. 2 and 5, the fourth inner surface area 243 can comprise an inclined surface extending from the second inner surface area 123, and the fourth inner surface area can comprise a flat surface connected the inclined surface to another inclined surface comprising a second end portion 129 of the second housing member 121. For example, as shown in FIGS. 3 and 6, the fourth inner surface area 243 extending from the second inner surface area 123 can comprise a vertical surface, a flat surface, an inclined surface, a flat surface, an inclined surface, and another flat surface, sequentially, although other combinations are possible in further embodiments.

In some embodiments, the first housing member 111 and/or the second housing member 121 can comprise a glass-based material, a ceramic-based material, a polymer-based material, and/or a metal-based material. Example embodiments of polymer-based materials include an acrylic (e.g., polymethylmethacrylate (PMMA)), an epoxy, silicone, a polyurethane, a polyolefin, a polyamide, a halide-containing polymer (e.g., polyvinylchloride or a fluorine-containing polymer), an elastomer, a urethane, phenolic resin, parylene, polyethylene terephthalate (PET), and/or polyether ether ketone (PEEK). Examples of epoxies include bisphenol-based epoxy resins, novolac-based epoxies, cycloaliphatic-based epoxies, and glycidylamine-based epoxies. Example embodiments of polyolefins include low molecular weight polyethylene (LDPE), high molecular weight polyethylene (HDPE), ultrahigh molecular weight polyethylene (UHMWPE), and polypropylene (PP). Example embodiments of fluorine-containing polymers include polytetrafluoroethylene (PTFE), polyvinylfluoride (PVF), polyvinylidene fluoride (PVDF), perfluoropolyether (PFPE), perfluorosulfonic acid (PFSA), a perfluoroalkoxy (PFA), fluorinated ethylene propylene (FEP) polymers, and ethylene tetrafluoro ethylene (ETFE) polymers. Example embodiments of elastomers include rubbers (e.g., polybutadiene, polyisoprene, chloroprene rubber, butyl rubber, nitrile rubber), polyurethanes, and block copolymers (e.g., styrene-butadiene, high-impact polystyrene, polydichlorophosphazene) comprising one or more of polystyrene, polydichlorophosphazene, and/or poly(5-ethylidene-2-norbornene). In some embodiments, the polymer-based materials can further comprise nanoparticles, for example, carbon black, carbon nanotubes, silica nanoparticles, or nanoparticles comprising a polymer. In some embodiments, the polymer-based material can further comprise fibers to form a polymer-fiber composite. Example embodiments of metal-based materials include various grades of stainless steel, aluminum, titanium, and/or alloys thereof. In some embodiments, the first housing member 111 and/or the second housing member 121 can comprise an elastic modulus within one or more of the ranges discussed above for the foldable substrate 201.

In some embodiments, the first length 105 and/or the width 103 of the foldable apparatus can be substantially equal to a corresponding length and/or the width of the first housing member 111. In some embodiments, the length and/or the width of the first housing member 111 can be substantially equal to a corresponding length (e.g., the first portion and half of the central portion) and/or the width of the foldable substrate 201. In some embodiments, the length and/or the width of the first housing member 111 can be greater than the corresponding length and/or width of the foldable substrate 201, for example, to enable a bevel and/or framing of the foldable substrate 201. In some embodiments, the second length 107 and/or the width 103 of the foldable apparatus can be substantially equal to a corresponding length and/or width of the second housing member 121. In some embodiments, the length and/or the width of the second housing member 121 can be substantially equal to a corresponding length (e.g., the second portion and half of the central portion) and/or the width of the foldable substrate 201. In some embodiments, the length and/or the width of the second housing member 121 can be greater than the corresponding length and/or width of the foldable substrate 201, for example, to enable a bevel and/or framing of the foldable substrate 201.

As shown in FIGS. 2-3, an angle “A” can be defined between the first plane 114 that the first inner surface area 113 extends along and the second plane 124 that the second inner surface area 123 extends along. As used herein, the region swept out by the angle “A” includes the foldable substrate 201 without including the first plane 114 or the second plane 124 other than at the endpoints of the range, and the angle “A” is reported as a positive value in degrees less than 180° (e.g., 18, |360°— A|) and is always reported as a positive value in degrees. In some embodiments, the first configuration (e.g., shown in FIGS. 1-3) can be characterized by an angle “A” of about 80° or more, about 85° or more, about 90° or more, about 95° or more, about 100° or more, about 105° or more, about 135° or less, about 130° or less, about 125° or less, about 120° or less, about 115° or less, or about 110° or less. In some embodiments, the first configuration (e.g., shown in FIGS. 1-3) can be characterized by an angle “A” in a range from about 80° to about 135°, from about 80° to about 130°, from about 85° to about 130°, from about 85° to about 125°, from about 90° to about 125°, from about 90° to about 120°, from about 95° to about 120°, from about 95° to about 115°, from about 100° to about 115°, from about 100° to about 110°, from about 105° to about 110°, or any range or subrange therebetween.

In some embodiments, as shown in FIGS. 5-6, the first plane 114 that the first inner surface area 113 extends along and the second plane 124 that the second inner surface area 123 extends along can be substantially parallel in the second configuration. As used herein, the angle “A” can be measured by superimposing the planes (e.g., translating one of the planes such that they impinge one another). In some embodiments, the second configuration (e.g., shown in FIGS. 4-6) can be characterized by the angle “A” of about 0° or more, about 2° or more, about 5° or more, about 10° or more, about 30° or less, about 25° or less, about 20° or less, or about 15° or less. In some embodiments, the second configuration (e.g., shown in FIGS. 4-6) can be characterized by the angle “A” in a range from about 0° to about 30°, from about 1° to about 30°, from about 1° to about 25°, from about 5° to about 25°, from about 5° to about 20°, from about 10° to about 20°, from about 10° to about 15°, or any range or subrange therebetween.

In some embodiments, as shown in FIGS. 2-3 and 5-6, the first housing member 111 can be pivotably attached to the second housing member 121. For example, as shown, the first housing member 111 can be attached to the second housing member 121 by a pin 241 about which the housing members pivot. The foldable apparatus 101 and 301 can be configured to be folded from the first configuration shown in FIGS. 2-3 comprising a first angle from about 80° to about 135° to the second configuration shown in FIGS. 5-6 comprising a second angle from about 0° to about 30°, for example, when the first housing member 111 and the second housing member 121 pivot about the pin 241 in the direction 112 (see FIG. 1). The foldable apparatus 401 and 601 can be configured to be unfolded from the second configuration shown in FIGS. 5-6 comprising the second angle from about 0° to about 30° to the first configuration shown in FIGS. 2-3 comprising the first angle from about 80° to about 135°, from example, when the first housing member 111 and the second housing member 121 pivot about the pin 241 opposite the direction 112 (see FIG. 1).

As shown in FIGS. 1-6, the foldable apparatus 101, 301, 401, and 601 comprise the support 131. As shown in FIGS. 2-3 and 5-6, the support 131 is attached to at least one of the first housing member 111 or the second housing member 121. In some embodiments, as shown in FIGS. 2 and 5, the support 131 can comprise a unitary support member 231 attached to the first housing member 111. In some embodiments, as shown in FIGS. 3 and 6, the support 131 can comprise a first support member 311 and a second support member 321.

In some embodiments, as shown in FIGS. 2 and 5, the unitary support member 231 can be integrally attached to the second end portion 119 of the first housing member 111. In further embodiments, the unitary support member 231 can be configured to receive the pin 241 and rotate about the pin to fold and/or unfold the foldable apparatus by moving the first housing member 111 relative to the second housing member 121, as discussed above. In some embodiments, as shown, the unitary support member 231 can comprise a monolithic support member. In some embodiments, as shown, the unitary support member 231 can comprise a third inner surface area 233. In further embodiments, as shown, the third inner surface area 233 can comprise a concave shape. In even further embodiments, as shown in FIG. 2, the third inner surface area 233 can comprise a concave shape corresponding to a convex shape of the second major surface 205 of the foldable substrate 201 in the central portion 271 when the foldable apparatus is in the first configuration.

In some embodiments, as shown in FIGS. 2 and 5, the third inner surface area 233 can face the second major surface 205 of the foldable substrate 201 in the central portion 271. In further embodiments, the unitary support member 231 can contact the foldable substrate 201 by the third inner surface area 233 of the unitary support member 231 contacting the second major surface 205 of the foldable substrate 201 in the central portion 271 when the foldable apparatus is in the first configuration. In even further embodiments, as shown in FIG. 2, the third inner surface area 233 can contact substantially the entire length of the second major surface 205 of the foldable substrate 201 in the central portion 271 when the foldable apparatus is in the first configuration. In still further embodiments, although not shown, the third inner surface area 233 can extend in the direction 104 and can contact the second major surface 205 of the foldable substrate 201 across substantially the entire width of the foldable substrate 201 in the central portion 271 when the foldable apparatus is in the first configuration.

In some embodiments, as shown in FIG. 2, the unitary support member 231 can comprise an end portion 239 opposite the first housing member 111. In further embodiments, the end portion 239 can substantially contact the second housing member 121, for example, where the second inner surface area 123 of the second housing member 121 intersects the fourth inner surface area 243 of the second housing member 121. In even further embodiments, the first inner surface area 113, the third inner surface area 233, and the second inner surface area 123 can form a substantially continuous inner surface area when the foldable apparatus is in the first configuration. In still further embodiments, the substantially continuous inner surface area defined by the first inner surface area 113, the third inner surface area 233, and the second inner surface area 123 can contact substantially the second major surface 205 (e.g., substantially the entire second major surface 205) of the foldable substrate 201 across substantially the length of the foldable substrate 201 when the foldable apparatus is in the first configuration. In yet further embodiments, the substantially continuous inner surface area can extend in the direction 104 and can contact the second major surface 205 of the foldable substrate 201 across substantially the entire width of the foldable substrate 201 when the foldable apparatus is in the first configuration.

In some embodiments, as shown in FIG. 5, the third inner surface area 233 can be spaced from the second major surface 205 of the foldable substrate 201 when the foldable apparatus is in the second configuration. In further embodiments, the end portion 239 can be spaced from the second major surface 205 of the foldable substrate 201 in the central portion 271 by a spacing width 407 that can be about 1 mm or more, about 2 mm or more, about 4 mm or more, about 6 mm or more, about 30 mm or less, about 20 mm or less, about 10 mm or less, or about 8 mm or less. In some embodiments, the spacing width 407 can be in a range from about 1 mm to about 30 mm, from about 1 mm to about 20 mm, from about 2 mm to about 20 mm, from about 2 mm to about 10 mm, from about 4 mm to about 10 mm, from about 4 mm to about 8 mm, from about 6 mm to about 8 mm, or any range or subrange therebetween.

In some embodiments, a reception area can be defined at least in part by the third inner surface area 233 of the unitary support member 231 and the fourth inner surface area 243 of the second housing member 121 when the foldable substrate is in the second configuration. The reception area can be configured to receive a folded portion (e.g., folded central portion 271) of the foldable substrate 201 when the foldable apparatus is in the second configuration, as shown in FIG. 5. In some embodiments, as shown, the end portion 239 of the unitary support member 231 and the second end portion 129 of the second housing member 121 can face each other and be within a short distance of each other (e.g., from about 1 μm to about 5 mm, from about 10 μm to about 2 mm, from about 100 μm to about 1 mm, from about 500 μm to about 1 mm, or any range or subrange therebetween). In some embodiments, as shown in FIG. 5, the reception area can allow the central portion 271 of the foldable substrate 201 positioned in the reception area to comprise a first maximum spacing distance 405 that is greater than a second maximum spacing distance 403 between the first portion 251 and the second portion 261 of the foldable substrate 201 and/or that is greater than a first distance 411. As used herein, a maximum spacing distance is the maximum distance in the direction of the thickness between a first point of the second major surface of the foldable substrate and a second point in the second major surface of the foldable substrate, where the first point and the second point are in the designated portion(s) of the foldable substrate and the first point and the second point are as far away as possible in the direction of the thickness when the foldable apparatus is in the second configuration. For example, with reference to FIG. 5, the first maximum spacing distance 405 is the maximum distance in the direction 202 of the thickness (e.g., substrate thickness 207) between a first point 406 on the second major surface 205 in the central portion 271 and a second point 408 on the second major surface 205 in the central portion 271 that are as a far apart as possible in the direction 202 and positioned in the reception area when the foldable apparatus is in the second configuration. In some embodiments, the first maximum spacing distance 405 can be substantially equal to a parallel plate distance (discussed below) of the foldable substrate 201 in the second configuration. Likewise, the second maximum spacing distance 403 is defined as the maximum distance in the direction 202 of the thickness (e.g., substrate thickness 207) between a first point 402 on the second major surface 205 in the first portion 251 of the foldable substrate 201 and a second point 404 on the second major surface 205 in the second portion 261 of the foldable substrate 201 that are as far apart as possible in the direction 202 when the foldable apparatus is in the second configuration. In some embodiments, as shown, the first maximum spacing distance 405 of the central portion 271 can be greater than a second maximum spacing distance 403 between the first portion 251 and the second portion 261 of the foldable substrate 201. As used herein, the first distance 411 is defined as the distance between the first plane 114 and the second plane 124 measured in the direction 202 of the thickness (e.g., substrate thickness 207) at the end portion 117 and 127 of the housing members 111 and 121 with the foldable apparatus in the second configuration. In some embodiments, as shown in FIG. 5, the first maximum spacing distance 405 of the central portion 271 can be greater than the first distance 411. In further embodiments, the first point 406 on the second major surface 205 of the foldable substrate 201 in the central portion 271 positioned in the reception area can be substantially impinged by the first plane 114 that the first inner surface area 113 extends along. In even further embodiments, as shown, the central portion 271 of the foldable substrate 201 positioned in the reception area can extend through the second plane 124 that the second inner surface area 123 extends along such that the second plane 124 is positioned between the first point 406 and the second point 408. In some embodiments, the first maximum spacing distance 405 can be greater than the second maximum spacing distance 403 between the first portion 251 and the second portion 261 of the foldable substrate 201 and/or greater than a first distance 411 by about 1 mm or more, about 2 mm or more, about 4 mm or more, about 6 mm or more, about 30 mm or less, about 20 mm or less, about 10 mm or less, or about 8 mm or less. In some embodiments, an amount that the first maximum spacing distance 405 is greater than the second maximum spacing distance 403 between the first portion 251 and the second portion 261 of the foldable substrate 201 and/or greater than a first distance 411 can be in a range from about 1 mm to about 30 mm, from about 1 mm to about 20 mm, from about 2 mm to about 20 mm, from about 2 mm to about 10 mm, from about 4 mm to about 10 mm, from about 4 mm to about 8 mm, from about 6 mm to about 8 mm, or any range or subrange therebetween.

In some embodiments, as shown in FIGS. 3 and 6, the support 131 can comprise a first support member 311 and a second support member 321. In further embodiments, as shown, the first support member 311 can be attached to the first housing member 111, and the second support member 321 can be attached to the second housing member 121. In even further embodiments, the first support member 311 can be attached to the first housing member 111 by a pin-in-slot joint comprising a pin 363 and a slot 365. In even further embodiments, the second support member 321 can be attached to the second housing member 121 by a pin-in-slot joint comprising a pin 353 and a slot 355. In still further embodiments, the second support member 321 can be configured to translate along a direction 357 of the pin-in-slot joint in transitioning from the first configuration shown in FIG. 3 and the second configuration shown in FIG. 6, for example, as the pin 353 translates in the direction 357, and/or vice versa. In still further embodiments, the first support member 311 can be configured to translate along a direction 367 of the pin-in-slot joint in transitioning from the first configuration shown in FIG. 3 and the second configuration shown in FIG. 6, for example, as the pin 363 translates in the direction 367, and/or vice versa. In further embodiments, as shown, the first support member 311 can comprise a first support surface area 319, and the second support member 321 can comprise a second support surface area 329. In even further embodiments, as shown in FIG. 3, an end portion 333 of the first support member 311 can substantially contact an end portion 335 of the second support member 321 such that the first support surface area 319 and the second support surface area 329 comprise a substantially continuous third surface area when the foldable apparatus is in the first configuration. In still further embodiments, as shown in FIG. 3, the third inner surface area 233 can comprise a concave shape corresponding to a convex shape of the second major surface 205 of the foldable substrate 201 in the central portion 271 when the foldable apparatus is in the first configuration, for example, when the first support surface area 319 comprises a concave shape corresponding to the convex shape of a portion of the second major surface 205 in the central portion 271 and the second support surface area 329 comprises a concave shape corresponding to the convex shape of a portion of the second major surface 205 in the central portion 271.

In some embodiments, as shown in FIGS. 3 and 6, the first support surface area 319 and the second support surface area 329 can face the second major surface 205 of the foldable substrate 201 in the central portion 271. In further embodiments, the first support member 311 can contact the foldable substrate 201 by the first support surface area 319 of the first support member 311 contacting the second major surface 205 of the foldable substrate 201 in the central portion 271 when the foldable apparatus is in the first configuration. In further embodiments, the second support member 321 can contact the foldable substrate 201 by the second support surface area 329 of the second support member 321 contacting the second major surface 205 of the foldable substrate 201 in the central portion 271 when the foldable apparatus is in the first configuration. In even further embodiments, as shown in FIG. 3, the third inner surface area 233 comprising the first support surface area 319 and the second support surface area 329 can contact substantially the entire length of the second major surface 205 of the foldable substrate 201 in the central portion 271 when the foldable apparatus is in the first configuration. In still further embodiments, although not shown, the third inner surface area 233 comprising the first support surface area 319 and the second support surface area 329 can extend in the direction 104 and can contact the second major surface 205 of the foldable substrate 201 across substantially the entire width of the foldable substrate 201 in the central portion 271 when the foldable apparatus is in the first configuration.

In some embodiments, as shown in FIG. 3, the first inner surface area 113, the third inner surface area comprising the first support surface area 319 and the second support surface area 329, and the second inner surface area 123 can form a substantially continuous inner surface area when the foldable apparatus is in the first configuration. In still further embodiments, the substantially continuous inner surface area defined by the first inner surface area 113, the third inner surface area comprising the first support surface area 319 and the second support surface area 329, and the second inner surface area 123 can contact substantially the second major surface 205 (e.g., substantially the entire second major surface 205) of the foldable substrate 201 across substantially the length of the foldable substrate 201 when the foldable apparatus is in the first configuration. In yet further embodiments, the substantially continuous inner surface area can extend in the direction 104 and can contact the second major surface 205 of the foldable substrate 201 across substantially the entire width of the foldable substrate 201 when the foldable apparatus is in the first configuration.

In some embodiments, as shown in FIG. 6, the third surface area comprising the first support surface area 319 and the second support surface area 329 can be spaced from the second major surface 205 of the foldable substrate 201 when the foldable apparatus is in the second configuration. In further embodiments, the end portion 333 of the first support member 311 can be spaced from the second major surface 205 of the foldable substrate 201 in the central portion 271 by a spacing width that can be within one or more of the ranges discussed above with reference to the spacing width 407. In further embodiments, the end portion 335 of the second support member 321 can be spaced from the second major surface 205 of the foldable substrate 201 in the central portion. In even further embodiments, the distance that the end portion 333 of the first support member 311 is spaced from the second major surface 205 can be greater than the distance that the end portion 335 of the second support member 321 is spaced from the second major surface 205. In some embodiments, a reception area can be defined at least in part by the first support surface area 319 of the first support member 311 and the second support surface area 329 of the second support member 321 when the foldable substrate is in the second configuration. The reception area can be configured to receive a folded portion (e.g., folded central portion 271) of the foldable substrate 201 when the foldable apparatus is in the second configuration, as shown in FIG. 6. In some embodiments, as shown, the first support surface area 319 and the end portion 333 of the first support member 311 can face the fourth inner surface area 243 of the second housing member 121. In some embodiments, as shown, the second support surface area 329 and the end portion 335 of the second support member 321 can face the first inner surface area 113 of the first housing member 111. In some embodiments, as shown in FIG. 6, the reception area can allow the central portion 271 of the foldable substrate 201 positioned in the reception area to comprise a maximum spacing distance 503 that can be substantially equal to a corresponding maximum spacing distance between the first portion 251 and the second portion 261 of the foldable substrate 201. For example, with reference to FIG. 6, the maximum spacing distance 503 is the maximum distance in the direction 202 of the thickness (e.g., substrate thickness 207) between a first point 502 on the second major surface 205 in the central portion 271 and a second point 504 on the second major surface 205 in the central portion 271 that are as a far apart as possible in the direction 202 and positioned in the reception area when the foldable apparatus is in the second configuration. In some embodiments, the maximum spacing distance 503 can be substantially equal to a parallel plate distance (discussed below) of the foldable substrate 201 in the second configuration. In further embodiments, the first point 502 on the second major surface 205 of the foldable apparatus in the central portion 271 positioned in the reception area can be substantially impinged by the first plane 114 that the first inner surface area 113 extends along. In further embodiments, the second point 504 on the second major surface 205 of the foldable apparatus in the central portion 271 positioned in the reception area can be substantially impinged by the second plane 124 that the second inner surface area 123 extends along.

In some embodiments, as shown in FIGS. 3 and 6, the second support member 321 can comprise an outer surface area 339 opposite the second support surface area 329. In further embodiments, a protrusion 331 can extend from the outer surface area 339 away from the second major surface 205 of the foldable substrate 201. In further embodiments, the protrusion 331 can extend from the outer surface area 339 by about 1 mm or more, about 2 mm or more, about 4 mm or more, about 6 mm or more, about 20 mm or less, about 15 mm or less, about 10 mm or less, or about 8 mm or less. In further embodiments, a distance that the protrusion 331 can extend from the outer surface area 339 can be in a range from about 1 mm to about 20 mm, from about 1 mm to about 15 mm, from about 2 mm to about 15 mm, from about 4 mm to about 15 mm, from about 4 mm to about 10 mm, from about 6 mm to about 10 mm, from about 6 mm to about 10 mm, or any range or subrange therebetween.

In some embodiments, as shown in FIGS. 3 and 6, the foldable apparatus 301 and 601 can comprise a platform 341. In further embodiments, as shown, the platform 341 can be disposed on the fourth inner surface area 243 of the second housing member 121. In further embodiments, as shown, the platform 341 can be attached to the second housing member 121 by a pin-in-slot connection comprising a pin 303 and a slot 305 that can allow translation along the direction 106 as shown by arrow 307 in FIG. 3. In further embodiments, the platform can comprise a platform surface 343 facing the outer surface area 339 of the second support member 321 and the second major surface 205 of the foldable substrate 201. In further embodiments, as shown, an edge surface 345 of the platform 341 can extend from the platform surface 343 towards the fourth inner surface area 243 of the second housing member 121. In further embodiments, as shown, a recess 351 can be defined between the platform 341 and the second housing member 121, for example between the edge surface 345 of the platform 341 and the fourth inner surface area 243 of the second housing member 121.

In some embodiments, as shown in FIGS. 3 and 6, a second end portion 337 of the second support member 321 can contact the platform surface 343. In further embodiments, as shown in FIG. 3, the protrusion 331 of the second support member 321 can contact the platform surface 343 in the first configuration. In further embodiments, as shown in FIG. 6, the protrusion 331 of the second support member 321 may not contact the platform surface 343, for example, because it has translated opposite the direction 106 from the first configuration shown in FIG. 3 to the second configuration shown in FIG. 6. In further embodiments, as shown between FIGS. 3 and 6, the protrusion 331 of the second support member 321 can be configured to translate along the direction 106 along the platform surface 343 towards the second housing member 121 (e.g., fourth inner surface area 243) in transitioning between the first configuration shown in FIG. 3 and the second configuration shown in FIG. 6 and/or vice versa. In further embodiments, as shown in FIG. 6, the protrusion 331 of the second support member 321 can extend into the recess 351.

In some embodiments, the support 131 comprising the unitary support member 231 or the first support member 311 and the second support member 321 can comprise one or more of the materials described above for the first housing member 111 and/or the second housing member 121. In further embodiments, the first support member 311 and the second support member 321 can comprise the same composition. In further embodiments, the support 131 (e.g., unitary support member 231 or the first support member 311 and the second support member 321) can comprise the same composition as the first housing member 111 and/or the second housing member 121. In further embodiments, the support 131 (e.g., unitary support member 231 or the first support member 311 and the second support member 321) can comprise a modulus of elasticity at 23° C. of about 1 GPa or more, for example, in a range from about 1 GPa to about 100 GPa, from about 1 GPa to about 80 GPa, from about 1 GPa to about 60 GPa, from about 1 GPa to about 20 GPa, from about 1 GPa to about 18 GPa, from about 2 GPa to about 18 GPa, from about 2 GPa to about 15 GPa, from about 3 GPa to about 15 GPa, from about 3 GPa to about 10 GPa, from about 5 GPa to about 10 GPa, or any range or subrange therebetween. In even further embodiments, the elastic modulus of the support 131 (e.g., unitary support member 231 or the first support member 311 and the second support member 321) can be less than the elastic modulus of the foldable substrate 201 (e.g., at 23° C.). Providing an elastic modulus of the support that is less than an elastic modulus of the foldable substrate can help the foldable substrate withstand impacts, for example, by absorbing and dissipating some of the impact's energy while supporting the foldable substrate.

In some embodiments, although not shown, the foldable apparatus can comprise a display device. In further embodiments, the first housing member and/or the second housing member can include a display device. The display device can comprise a liquid crystal display (LCD), an electrophoretic displays (EPD), an organic light-emitting diode (OLED) display, or a plasma display panel (PDP). In some embodiments, foldable apparatus comprising the display device can be part of a portable electronic device, for example, a consumer electronic product, a smartphone, a tablet, a wearable device, or a laptop. A consumer electronic product may include a housing comprising a front surface, a back surface, and side surfaces. For example, consumer electronic products include mobile phones, tablets, computers, navigation systems, wearable devices (e.g., watches) and the like. The consumer electronic product can comprise electrical components at least partially within the housing. The electrical components can comprise a controller, a memory, and a display. The display can be at or adjacent to the front surface of the housing. The foldable apparatus can comprise a cover substrate disposed over the display, wherein at least one of a portion of the housing or the cover substrate comprises the foldable apparatus described herein. In some embodiments, the foldable apparatus can comprise at least a portion of an architectural article, a transportation article (e.g., automotive, trains, aircraft, sea craft, etc.), an appliance article, or any article that may benefit from some transparency, scratch-resistance, abrasion resistance or a combination thereof.

In some embodiments, although not shown, the foldable apparatus 101, 301, 401, and 601 and/or the foldable test apparatus 701 can comprise an optional coating. The coating can comprise a coating thickness that can be about 0.1 μm or more, about 1 μm or more, about 5 μm or more, about 10 μm or more, about 15 μm or more, about 20 μm or more, about 25 μm or more, about 40 μm or more, about 50 μm or more, about 60 μm or more, about 70 μm or more, about 80 μm or more, about 90 μm or more, about 200 μm or less, about 100 μm or less, or about 50 μm or less, about 30 μm or less, about 25 μm or less, about 20 μm or less, about 20 μm or less, about 15 μm or less, or about 10 μm or less. In some embodiments, the coating thickness can be in a range from about 0.1 μm to about 200 μm, from about 1 μm to about 200 μm, from about 10 μm to about 200 μm, from about 50 μm to about 200 μm, from about 0.1 μm to about 100 μm, from about 1 μm to about 100 μm, from about 10 μm to about 100 μm, from about 20 μm to about 100 μm, from about 30 μm to about 100 μm, from about 40 μm to about 100 μm, from about 50 μm to about 100 μm, from about 60 μm to about 100 μm, from about 70 μm to about 100 μm, from about 80 μm to about 100 μm, from about 90 μm to about 100 μm, from about 0.1 μm to about 50 μm, from about 1 μm to about 50 μm, from about 10 μm to about 50 μm, or any range or subrange therebetween. In further embodiments, the coating thickness can be in a range from about 0.1 μm to about 50 μm, from about 0.1 μm to about 30 μm, from about 0.1 μm to about 25 μm, from about 0.1 μm to about 20 μm, from about 0.1 μm to about 15 μm, from about 0.1 μm to about 10 μm. In some embodiments, the coating thickness can be in a range from about 1 μm to about 30 μm, from about 1 μm to about 25 μm, from about 1 μm to about 20 μm, from about 1 μm to about 15 μm, from about 1 μm to about 10 μm. In some embodiments, the coating thickness can be in a range from about 5 μm to about 30 μm, from about 5 μm to about 25 μm, from about 5 μm to about 20 μm, from about 5 μm to about 15 μm, from about 5 μm to about 10 μm, from about 10 μm to about 30 μm, from about 10 μm to about 25 μm, from about 10 μm to about 20 μm, from about 10 μm to about 15 μm, from about 15 μm to about 30 μm, from about 15 μm to about 25 μm, from about 15 μm to about 20 μm, from about 20 μm to about 30 μm, from about 20 μm to about 25 μm, or any range or subrange therebetween. In some embodiments, the coating thickness can be in a range from about 5 μm to about 30 μm, from about 5 μm to about 25 μm, from about 10 μm to about 25 μm, from about 10 μm to about 20 μm, from about 10 μm to about 15 μm, or any range or subrange therebetween. In some embodiments, although not shown, the coating can be disposed over the first major surface of the foldable substrate (e.g., in the first portion, in the second portion, and/or in the central portion).

In some embodiments, the coating can comprise a polymeric hard coating. In further embodiments, the polymeric hard coating can comprise one or more of an ethylene-acid copolymer, a polyurethane-based polymer, an acrylate resin, and/or a mercapto-ester resin. Example embodiments of ethylene-acid copolymers include ethylene-acrylic acid copolymers, ethylene-methacrylic acid copolymers, and ethylene-acrylic-methacrylic acid terpolymers (e.g., Nucrel, manufactured by DuPont), ionomers of ethylene acid copolymers (e.g., Surlyn, manufactured by DuPont), and ethylene-acrylic acid copolymer amine dispersions (e.g., Aquacer, manufactured by BYK). Example embodiments of polyurethane-based polymers include aqueous modified polyurethane dispersions (e.g., Eleglas®, manufactured by Axalta). Example embodiments of acrylate resins which can be UV curable include acrylate resins (e.g., Uvekol® resin, manufactured by Allinex), cyanoacrylate adhesives (e.g., Permabond® UV620, manufactured by Krayden), and UV radical acrylic resins (e.g., Ultrabond windshield repair resin, for example, Ultrabond (45CPS)). Example embodiments of mercapto-ester resins include mercapto-ester triallyl isocyanates (e.g., Norland optical adhesive NOA 61). In further embodiments, the polymeric hard coating can comprise ethylene-acrylic acid copolymers and ethylene-methacrylic acid copolymers, which may be ionomerized to form ionomer resins through neutralization of the carboxylic acid residue with typically alkali metal ions, for example sodium and potassium, and also zinc. Such ethylene-acrylic acid and ethylene-methacrylic acid ionomers may be dispersed within water and coated onto the substrate to form an ionomer coating. Alternatively, such acid copolymers may be neutralized with ammonia which, after coating and drying liberates the ammonia to reform the acid copolymer as the polymeric hard coating. By providing a coating comprising a polymeric hard coating, the foldable apparatus can comprise low energy fracture.

In some embodiments, the coating can comprise a polymeric coating comprising an optically transparent polymeric hard-coat layer. Suitable materials for an optically transparent polymeric hard-coat layer include, but are not limited to: a cured acrylate resin material, an inorganic-organic hybrid polymeric material, an aliphatic or aromatic hexafunctional urethane acrylate, a siloxane-based hybrid material, and a nanocomposite material, for example, an epoxy and urethane material with nanosilicate. In some embodiments, an optically transparent polymeric hard-coat layer may consist essentially of one or more of these materials. In some embodiments, an optically transparent polymeric hard-coat layer may consist of one or more of these materials. As used herein, “inorganic-organic hybrid polymeric material” means a polymeric material comprising monomers with inorganic and organic components. An inorganic-organic hybrid polymer is obtained by a polymerization reaction between monomers having an inorganic group and an organic group. An inorganic-organic hybrid polymer is not a nanocomposite material comprising separate inorganic and organic constituents or phases, for example, inorganic particulates dispersed within an organic matrix. More specifically, suitable materials for an optically transparent polymeric (OTP) hard-coat layer include, but are not limited to, a polyimide, a polyethylene terephthalate (PET), a polycarbonate (PC), a poly methyl methacrylate (PMMA), organic polymer materials, inorganic-organic hybrid polymeric materials, and aliphatic or aromatic hexafunctional urethane acrylates. In some embodiments, an OTP hard-coat layer may consist essentially of an organic polymer material, an inorganic-organic hybrid polymeric material, or aliphatic or aromatic hexafunctional urethane acrylate. In some embodiments, an OTP hard-coat layer may consist of a polyimide, an organic polymer material, an inorganic-organic hybrid polymeric material, or aliphatic or aromatic hexafunctional urethane acrylate. In some embodiments, an OTP hard-coat layer may include a nanocomposite material. In some embodiments, an OTP hard-coat layer may include a nano-silicate at least one of epoxy and urethane materials. Suitable compositions for such an OTP hard-coat layer are described in U.S. Pat. Pub. No. 2015/0110990, which is hereby incorporated by reference in its entirety by reference thereto. As used herein, “organic polymer material” means a polymeric material comprising monomers with only organic components. In some embodiments, an OTP hard-coat layer may comprise an organic polymer material manufactured by Gunze Limited and having a hardness of 9H, for example, Gunze's “Highly Durable Transparent Film.” As used herein, “inorganic-organic hybrid polymeric material” means a polymeric material comprising monomers with inorganic and organic components. An inorganic-organic hybrid polymer is obtained by a polymerization reaction between monomers having an inorganic group and an organic group. An inorganic-organic hybrid polymer is not a nanocomposite material comprising separate inorganic and organic constituents or phases, for example, inorganic particulates dispersed within an organic matrix. In some embodiments, the inorganic-organic hybrid polymeric material may include polymerized monomers comprising an inorganic silicon-based group, for example, a silsesquioxane polymer. A silsesquioxane polymer may be, for example, an alky-silsesquioxane, an aryl-silsesquioxane, or an aryl alkyl-silsesquioxane having the following chemical structure: (RSiO_{1.5})ₙ, where R is an organic group for example, but not limited to, methyl or phenyl. In some embodiments, an OTP hard-coat layer may comprise a silsesquioxane polymer combined with an organic matrix, for example, SILPLUS manufactured by Nippon Steel Chemical Co., Ltd. In some embodiments, an OTP hard-coat layer may comprise 90 wt % to 95 wt % aromatic hexafunctional urethane acrylate (e.g., PU662NT (Aromatic hexafunctional urethane acrylate) manufactured by Miwon Specialty Chemical Co.) and 10 wt % to 5 wt % photo-initiator (e.g., Darocur 1173 manufactured by Ciba Specialty Chemicals Corporation) with a hardness of 8H or more. In some embodiments, an OTP hard-coat layer composed of an aliphatic or aromatic hexafunctional urethane acrylate may be formed as a stand-alone layer by spin-coating the layer on a polyethylene terephthalate (PET) substrate, curing the urethane acrylate, and removing the urethane acrylate layer from the PET substrate. An OTP hard-coat layer may have a coating thickness in a range of 1 μm to 150 μm, including subranges. For example, the coating thickness can be in a range from 10 μm to 140 μm, from 20 μm to 130 30 μm to 120 μm, from 40 μm to 110 μm, from 50 μm to 100 μm, from 60 μm to 90 μm, 70 μm, 80 μm, from 2 μm to 140 μm, from 4 μm to 130 μm, from 6 μm to 120 μm, from 8 μm to 110 μm, from 10 μm to 100 μm, from 10 μm to 90 μm, 10 μm, 80 μm, 10 μm, 70 μm, 10 μm, 60 μm, 10 μm, 50 μm, or within a range having any two of these values as endpoints. In some embodiments, an OTP hard-coat layer may be a single monolithic layer. In some embodiments, an OTP hard-coat layer may be an inorganic-organic hybrid polymeric material layer or an organic polymer material layer having a thickness in the range of 80 μm to 120 μm, including subranges. For example, an OTP hard-coat layer comprising an inorganic-organic hybrid polymeric material or an organic polymer material may have a thickness of from 80 μm to 110 μm, 90 μm to 100 μm, or within a range having any two of these values as endpoints. In some embodiments, an OTP hard-coat layer may be an aliphatic or aromatic hexafunctional urethane acrylate material layer having a thickness in the range of 10 μm to 60 μm, including subranges. For example, an OTP hard-coat layer comprising an aliphatic or aromatic hexafunctional urethane acrylate material may have a thickness of 10 μm to 55 μm, 10 μm to 50 μm, 10 μm to 40 μm, 10 μm to 45 μm, 10 μm to 40 μm, 10 μm to 35 μm, 10 μm to 30 μm, 10 μm to 25 μm, 10 μm to 20 μm, or within a range having any two of these values as endpoints.

In some embodiments, the coating, if provided, may also comprise one or more of an easy-to-clean coating, a low-friction coating, an oleophobic coating, a diamond-like coating, a scratch-resistant coating, and/or an abrasion-resistant coating. A scratch-resistant coating may comprise an oxynitride, for example, aluminum oxynitride or silicon oxynitride with a thickness of about 500 micrometers or more. In such embodiments, the abrasion-resistant layer may comprise the same material as the scratch-resistant layer. In some embodiments, a low friction coating may comprise a highly fluorinated silane coupling agent, for example, an alkyl fluorosilane with oxymethyl groups pendant on the silicon atom. In such embodiments, an easy-to-clean coating may comprise the same material as the low friction coating. In other embodiments, the easy-to-clean coating may comprise a protonatable group, for example an amine, or an alkyl aminosilane with oxymethyl groups pendant on the silicon atom. In such embodiments, the oleophobic coating may comprise the same material as the easy-to-clean coating. In some embodiments, a diamond-like coating comprises carbon and may be created by applying a high voltage potential in the presence of a hydrocarbon plasma.

In some embodiments, the foldable substrate 201 can comprise a glass-based substrate and/or ceramic-based substrate, as described above. In some embodiments, one or more portions of the foldable substrate 201 may comprise a compressive stress region. In some embodiments, the compressive stress region may be created by chemically strengthening. Chemically strengthening may comprise an ion exchange process, where ions in a surface layer are replaced by—or exchanged with—larger ions having the same valence or oxidation state. Methods of chemically strengthening will be discussed later. Without wishing to be bound by theory, chemically strengthening the foldable substrate 201 (e.g., in the first portion, in the second portion, and/or in the central portion) can enable good impact resistance and/or good puncture resistance (e.g., resists failure for a pen drop height of 10 centimeters (cm) or more, 15 cm or more, or 20 cm or more). Without wishing to be bound by theory, chemically strengthening the foldable substrate 201 (e.g., first major surface, second major surface) can enable small (e.g., smaller than about 10 mm or less) bend radii because the compressive stress from the chemical strengthening can counteract the bend-induced tensile stress on the outermost surface of the substrate. A compressive stress region may extend into a portion of the first portion and/or second portion for a depth called the depth of compression. As used herein, depth of compression means the depth at which the stress in the chemically strengthened substrates and/or portions described herein changes from compressive stress to tensile stress. Depth of compression may be measured by a surface stress meter or a scattered light polariscope (SCALP, wherein values reported herein were made using SCALP-5 made by Glasstress Co., Estonia) depending on the ion exchange treatment and the thickness of the article being measured. Where the stress in the substrate and/or portion is generated by exchanging potassium ions into the substrate, a surface stress meter, for example, the FSM-6000 (Orihara Industrial Co., Ltd. (Japan)), is used to measure depth of compression. Unless specified otherwise, compressive stress (including surface CS) is measured by surface stress meter (FSM) using commercially available instruments, for example the FSM-6000, manufactured by Orihara. Surface stress measurements rely upon the accurate measurement of the stress optical coefficient (SOC), which is related to the birefringence of the glass. Unless specified otherwise, SOC is measured according to Procedure C (Glass Disc Method) described in ASTM standard C770-16, entitled “Standard Test Method for Measurement of Glass Stress-Optical Coefficient,” the contents of which are incorporated herein by reference in their entirety. Where the stress is generated by exchanging sodium ions into the substrate, and the article being measured is thicker than about 400 μm, SCALP is used to measure the depth of compression and central tension (CT). Where the stress in the substrate and/or portion is generated by exchanging both potassium and sodium ions into the substrate and/or portion, and the article being measured is thicker than about 400 μm, the depth of compression and CT are measured by SCALP. Without wishing to be bound by theory, the exchange depth of sodium may indicate the depth of compression while the exchange depth of potassium ions may indicate a change in the magnitude of the compressive stress (but not the change in stress from compressive to tensile). The refracted near-field (RNF; the RNF method is described in U.S. Pat. No. 8,854,623, entitled “Systems and methods for measuring a profile characteristic of a glass sample”, which is incorporated herein by reference in its entirety) method also may be used to derive a graphical representation of the stress profile. When the RNF method is utilized to derive a graphical representation of the stress profile, the maximum central tension value provided by SCALP is utilized in the RNF method. The graphical representation of the stress profile derived by RNF is force balanced and calibrated to the maximum central tension value provided by a SCALP measurement. As used herein, “depth of layer” means the depth that the ions have exchanged into the substrate and/or portion (e.g., sodium, potassium). Through the disclosure, when the maximum central tension cannot be measured directly by SCALP (as when the article being measured is thinner than about 400 μm) the maximum central tension can be approximated by a product of a maximum compressive stress and a depth of compression divided by the difference between the thickness of the substrate and twice the depth of compression, wherein the compressive stress and depth of compression are measured by FSM.

In some embodiments, the foldable substrate 201 comprising the glass-based substrate and/or the ceramic-based substrate may comprise a first compressive stress region at the first major surface 203 that can extend to a first depth of compression from the first major surface 203. In some embodiments, the foldable substrate 201 comprising the glass-based substrate and/or the ceramic-based substrate may comprise a second compressive stress region at the second major surface 205 that can extend to a second depth of the compression from the second major surface 205. In some embodiments, the central portion 271 of the foldable substrate 201 can comprise the first compressive stress region and/or the second compressive stress region. In further embodiments, the first portion 251 of the foldable substrate and/or the second portion 261 of the foldable substrate 201 can comprise the first compressive stress region and/or the second compressive stress region.

In some embodiments, the first depth of compression and/or the second depth of compression as a percentage of the substrate thickness 207 can be about 1% or more, about 5% or more, about 10% or more, about 30% or less, about 25% or less, or about 20% or less. In some embodiments, the first depth of compression and/or the second depth of compression as a percentage of the substrate thickness 207 can be in a range from about 1% to about 30%, from about 5% to about 30%, from about 10% to about 30%, from about 10% to about 25%, from about 15% to about 25%, from about 15% to about 20%, or any range or subrange therebetween. In further embodiments, the first depth of compression can be substantially equal to the second depth of compression. In some embodiments, the first depth of compression and/or the second depth of compression can be about 1 μm or more, about 10 μm or more, about 50 μm or more, about 200 μm or less, about 150 μm or less, or about 100 μm or less. In some embodiments, the first depth of compression and/or the second depth of compression can be in a range from about 1 μm to about 200 μm, from about 1 μm to about 150 μm, from about 10 μm to about 150 μm, from about 10 μm to about 100 μm, from about 50 μm to about 100 μm, or any range or subrange therebetween. By providing a foldable substrate comprising a first depth of compression and/or a second depth of compression in a range from about 1% to about 30% of the substrate thickness, good impact resistance, good puncture resistance, and/or good folding performance can be enabled.

In some embodiments, the first compressive stress region can comprise a first maximum compressive stress. In some embodiments, the second compressive stress region can comprise a second maximum compressive stress. In further embodiments, the first maximum compressive stress and/or the second maximum compressive stress can be about 100 MegaPascals (MPa) or more, about 300 MPa or more, about 500 MPa or more, about 600 MPa or more, about 700 MPa or more, about 1,500 MPa or less, about 1,200 MPa or less, or about 1,000 MPa or less. In further embodiments, the first maximum compressive stress and/or the second maximum compressive stress can be in a range from about 100 MPa to about 1,500 MPa, from about 300 MPa to about 1,500 MPa, from about 500 MPa to about 1,500 MPa, from about 500 MPa to about 1,200 MPa, from about 500 MPa to about 1,000 MPa, from about 600 MPa to about 1,000 MPa, or from about 700 MPa to about 1,000 MPa, or any range or subrange therebetween. In some embodiments, the first maximum compressive stress and/or the second maximum compressive stress can be in a range from about 500 MPa to about 1,500 MPa, from about 600 MPa to about 1,500 MPa, from about 600 MPa to about 1,200 MPa, from about 700 MPa to about 1,200 MPa, from about 700 MPa to about 1,000 MPa, or any range or subrange therebetween. By providing a first maximum compressive stress and/or a second maximum compressive stress in a range from about 500 MPa to about 1,500 MPa, good impact resistance, good puncture resistance, and/or good folding performance can be enabled.

As used herein, “fictive temperature” of a glass-based substrate and/or a ceramic-based substrate refers to the temperature at which an equilibrated substrate has the same properties as the substrate at an actual temperature less than the fictive temperature. Without wishing to be bound by theory, the fictive temperature can be a measure of the structure of the foldable substrate, for example, the statistical distribution of angles of —Si—O—Si chemical bonds. Without wishing to be bound by theory, the fictive temperature depends on the thermal history of the foldable substrate, especially the thermal history (e.g., cooling rate, annealing temperatures and times) within a glass-transition range, for example, between an anneal point temperature and a softening point temperature. As used herein, an “anneal point temperature” of a glass-based substrate and/or a ceramic-based substrate means a temperature at which a viscosity of the substrate comprises 10 12 Pascal-seconds (Pa-s). As used herein, a “softening point temperature” of a glass-based substrate and/or a ceramic-based substrate means a temperature at which a viscosity of the substrate comprises 10 66 Pa-s. As used herein, the viscosity of a glass-based substrate and/or a ceramic-based substrate can be measured using ASTM C1351M-96(2017) when the glass-forming material is below the softening point. For example, the viscosity can be determined by measuring the viscosity using ASTM C1351M-96(2017) when a sample of the glass-based substrate and/or ceramic-based substrate is at a predetermined temperature.

In some embodiments, the fictive temperature of the foldable substrate 201 can be substantially equal to an anneal point temperature of the foldable substrate 201. In some embodiments, the fictive temperature of the foldable substrate 201 can be greater than the anneal point temperature of the foldable substrate 201 by 0° C. or more, about 1° C. or more, about 5° C. or more, about 10° C. or more, about 50° C. or less, about 30° C. or less, about 20° C. or less, or about 15° C. or less. In some embodiments, an amount that the fictive temperature of the foldable substrate 201 can be greater than the anneal point temperature of the foldable substrate 201 can be in a range from 0° C. to about 50° C., from 0° C. to about 30° C., from about 1° C. to about 30° C., from about 1° C. to about 20° C., from about 5° C. to about 20° C., from about 5° C. to about 15° C., from about 10° C. to about 15° C., or any range or subrange therebetween. In some embodiments, an amount that the fictive temperature of the foldable substrate 201 can be greater than the anneal point temperature of the foldable substrate 201 can be in a range from 0° C. to about 20° C., from 0° C. to about 15° C., from 0° C. to about 10° C., from about 1° C. to about 10° C., from about 1° C. to about 8° C., from about 1° C. to about 5° C., from about 1° C. to about 3° C., or any range or subrange therebetween. Providing a lower fictive temperature (e.g., a fictive temperature substantially equal to the anneal point temperature) can increase the density of the foldable substrate (e.g., decreased molar volume, compaction) and can enable greater compressive stresses to be developed as a result of chemically strengthening the foldable substrate, for example, because the larger ions exchanged into the foldable substrate create larger stresses in a denser substrate because an average spacing between atoms is smaller in such substrates.

In some embodiments, the first adhesive 211 and/or the second adhesive 221 can be optically clear. The first adhesive 211 and/or the second adhesive 221 can comprise a first index of refraction. The first refractive index may be a function of a wavelength of light passing through the optically clear adhesive. For light of a first wavelength, a refractive index of a material is defined as the ratio between the speed of light in a vacuum and the speed of light in the corresponding material. Without wishing to be bound by theory, a refractive index of the optically clear adhesive can be determined using a ratio of a sine of a first angle to a sine of a second angle, where light of the first wavelength is incident from air on a surface of the optically clear adhesive at the first angle and refracts at the surface of the optically clear adhesive to propagate light within the optically clear adhesive at a second angle. The first angle and the second angle are both measured relative to a normal of a surface of the optically clear adhesive. As used herein, the refractive index is measured in accordance with ASTM E1967-19, where the first wavelength comprises 589 nm. In some embodiments, the first refractive index of the first adhesive 211 and/or the second adhesive 221 may be about 1 or more, about 1.3 or more, about 1.4 or more, about 1.45 or more, about 1.49 or more, about 3 or less, about 2 or less, about 1.7 or less, about 1.6 or less, or about 1.55 or less. In some embodiments, the first refractive index of the first adhesive 211 and/or the second adhesive 221 can be in a range from about 1 to about 3, from about 1 to about 2 from about 1 to about 1.7, from about 1.3 to about 3, from about 1.3 to about 2, from about 1.3 to about 1.7, from about 1.4 to about 2, from about 1.4 to about 1.7, from about 1.45 to about 1.7, from about 1.45 to about 1.6, from about 1.49 to about 1.55, or any range or subrange therebetween. In some embodiments, the refractive index of the first adhesive 211 can be substantially equal to the refractive index of the second adhesive 221. In some embodiments, the refractive index of the first adhesive 211 can be greater than or less than the refractive index of the second adhesive 221.

In some embodiments, the foldable substrate 201 can comprise a second index of refraction. A differential equal to the absolute value of the difference between the second index of refraction of the foldable substrate 201 and the first index of refraction of the first adhesive 211 and/or the second adhesive 221 can be about 0.1 or less, about 0.07 or less, about 0.05 or less, about 0.001 or more, about 0.01 or more, or about 0.02 or more. In some embodiments, the differential is in a range from about 0.001 to about 0.1, from about 0.001 to about 0.07, from about 0.001 to about 0.05, from about 0.01 to about 0.1, from about 0.01 to about 0.07, from about 0.01 to about 0.05, from about 0.02 to about 0.1, from about 0.02 to about 0.07, from about 0.02 to about 0.05, or any range or subrange therebetween. In some embodiments, the second index of refraction of the foldable substrate 201 may be greater than the first index of refraction of the first adhesive 211 and/or the second adhesive 221. In some embodiments, the second index of refraction of the foldable substrate 201 may be less than the first index of refraction of the first adhesive 211 and/or the second adhesive 221.

FIGS. 4-6 schematically illustrate embodiments of a foldable apparatus 401 and 601 in accordance with embodiments of the disclosure in the second configuration. As shown, the foldable apparatus 401 and 601 is folded such that the first major surface 203 of the foldable substrate 201 is on the inside of the folded foldable apparatus 401 and 601. In both FIGS. 5-6, a user would view an electronic device (e.g., display device) within the first housing member 111 and/or second housing member 121 through the foldable substrate 201 and, thus, would be positioned on the side of the first major surface 203.

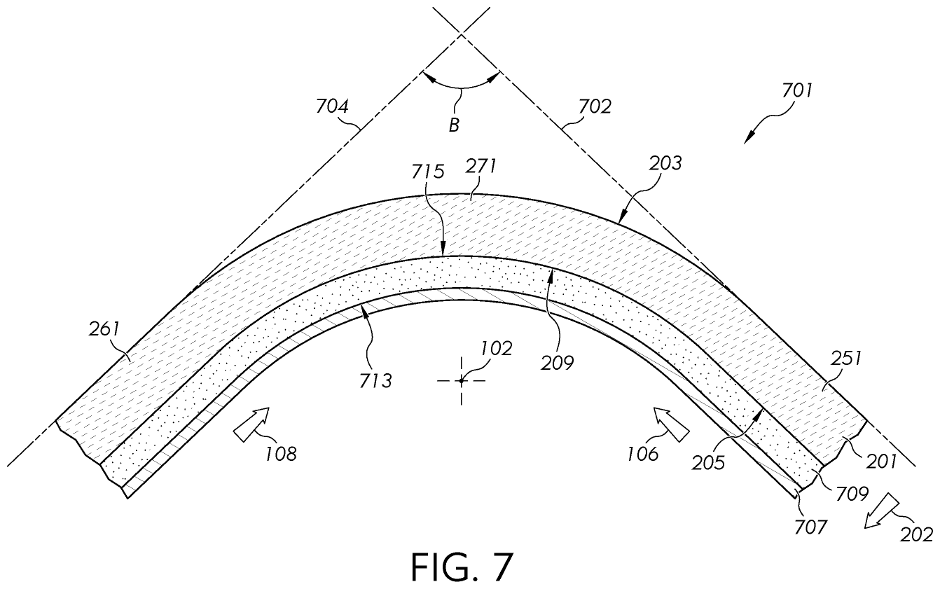

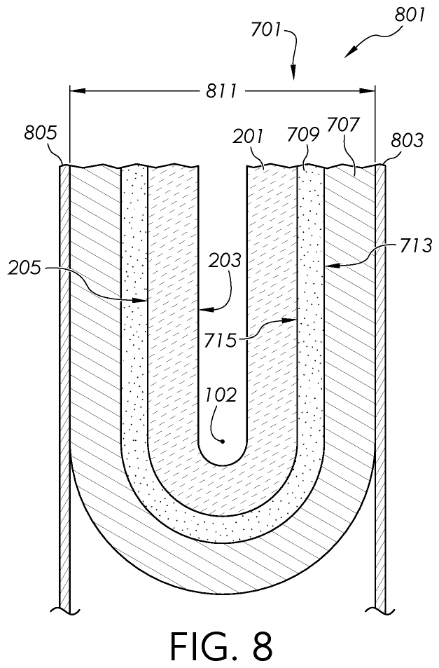

FIGS. 7-8 schematically illustrate an exemplary embodiment of a foldable test apparatus 701 in accordance with embodiments of the disclosure in a folded configuration (e.g., second configuration). FIG. 8 will be used to discuss the “effective minimum bend radius” and parallel plate distance” (e.g., of the foldable substrate 201) while FIG. 7 will be used to discuss the neutral stress configuration.

As used herein, “foldable” includes complete folding, partial folding, bending, flexing, or multiple capabilities. As used herein, the terms “fail,” “failure” and the like refer to breakage, destruction, delamination, or crack propagation. A foldable apparatus achieves an effective bend radius of “X,” or has an effective bend radius of “X,” or comprises an effective bend radius of “X” if it resists failure when the foldable apparatus is held at “X” radius for 24 hours at about 85° C. and about 85% relative humidity. Likewise, a foldable apparatus achieves a parallel plate distance of “X,” or has a parallel plate distance of “X,” or comprises a parallel plate distance of “X” if it resists failure when the foldable apparatus is held at a parallel plate distance of “X” for 24 hours at about 85° C. and about 85% relative humidity.

As used herein, the “effective minimum bend radius” and “parallel plate distance” of a foldable substrate is measured with the following test configuration and process using a parallel plate apparatus 801 (see FIG. 8) that comprises a pair of parallel rigid stainless-steel plates 803, 805 comprising a first rigid stainless-steel plate 803 and a second rigid stainless-steel plate 805. When measuring the “effective minimum bend radius” or the “parallel plate distance”, a test adhesive layer 709 comprises a thickness of 50 μm between a fifth contact surface 713 of the test adhesive layer 709 and a sixth contact surface 715 of the test adhesive layer 709. The test adhesive layer comprises an optically clear adhesive comprising an elastic modulus of 0.1 MPa. When measuring the “effective minimum bend radius” or the “parallel plate distance”, the test is conducted with a 100 μm thick sheet 707 of polyethylene terephthalate (PET) rather than the first housing member 111, the support 131, and/or second housing member 121. Thus, during the test to determine the “effective minimum bend radius” or the “parallel plate distance” of a configuration of the foldable substrate 201, the foldable test apparatus 701 is produced by using the 100 μm thick sheet 707 of polyethylene terephthalate (PET) rather than the first housing member 111, the support 131, and/or second housing member 121. When preparing a foldable test apparatus for foldable apparatus 101, 301, 401, or 601 shown in FIGS. 1-6 to test the foldable substrate 201, the sixth contact surface 715 of the test adhesive layer 709 is disposed over the second major surface 205 in the first portion 251, the second portion 261, and the central portion 271 of the foldable substrate 201, and then the PET sheet 707 is disposed over the fifth contact surface 713 of the test adhesive layer 709. When preparing a foldable test apparatus to test the foldable substrate 201, the first adhesive 211, second adhesive 221, first housing member 111, second housing member 121, and support 131 are removed before applying the test adhesive layer 709 and the PET sheet 707. While FIG. 8 shows the foldable test apparatus 701 for testing the parallel plate distance and/or effective bend radius that the foldable substrate 201 can withstand, the foldable apparatus 101, 301, 401, and/or 601 shown in FIGS. 1-6 can be tested as is between the pair of parallel rigid stainless-steel plates 803, 805 without the further modification discussed above. For determining a “parallel plate distance”, the distance between the parallel plates is reduced at a rate of 50 μm/second until the parallel plate distance 811 is equal to the “parallel plate distance” to be tested. Then, the parallel plates are held at the “parallel plate distance” to be tested for 24 hours at about 85° C. and about 85% relative humidity. As used herein, the “minimum parallel plate distance” is the smallest parallel plate distance that the foldable apparatus can withstand without failure under the conditions and configuration described above. For determining the “effective minimum bend radius”, the distance between the parallel plates is reduced at a rate of 50 μm/second until the parallel plate distance 811 is equal to twice the “effective minimum bend radius” to be tested. Then, the parallel plates are held at twice the effective minimum bend radius to be tested for 24 hours at about 85° C. and about 85% relative humidity. As used herein, the “effective minimum bend radius” is the smallest effective bend radius that the foldable apparatus can withstand without failure under the conditions and configuration described above.

In some embodiments, the foldable substrate 201 can achieve a parallel plate distance of 100 mm or less, 50 mm or less, 20 mm or less, 10 mm or less, 5 mm or less, or 3 mm or less. In further embodiments, the foldable substrate 201 (e.g., foldable test apparatus 701) can achieve a parallel plate distance of 50 millimeters (mm), or 20 mm, or 10 mm, or 5 mm, or 3 mm, or 2 mm, or 1 mm. In some embodiments, the foldable substrate 201 (e.g., foldable test apparatus 701) can comprise a minimum parallel plate distance of about 40 mm or less, about 20 mm or less, about 10 mm or less, about 5 mm or less, about 3 mm or less, about 1 mm or more, about 3 mm or more, about 3 mm or more, about 5 mm or more, or about 10 mm or more. In some embodiments, the foldable substrate 201 (e.g., foldable test apparatus 701) can comprise an effective minimum bend radius in a range from about 1 mm to about 40 mm, from about 1 mm to about 20 mm, from about 1 mm to about 10 mm, from about 1 mm to about 5 mm, from about 1 mm to about 3 mm, from about 3 mm to about 40 mm, from about 3 mm to about 40 mm, from about 3 mm to about 20 mm, from about 3 mm to about 10 mm, from about 3 mm to about 5 mm, from about 5 mm to about 10 mm, or any range or subrange therebetween.

In some embodiments, the foldable apparatus 101, 301, 401, and/or 601 can achieve a parallel plate distance of 100 mm or less, 50 mm or less, 40 mm or less, 30 mm or less, 20 mm or less, 10 mm or less, or 5 mm or less. In further embodiments, the foldable apparatus 101, 301, 401, and/or 601 can achieve a parallel plate distance of 50 millimeters (mm), or 40 mm, or 30 mm, or 20 mm, or 10 mm, or 5 mm, or 3 mm. In some embodiments, the foldable apparatus 101, 301, 401, and/or 601 can comprise a minimum parallel plate distance of about 50 mm or less, about 40 mm or less, about 30 mm or less, about 20 mm or less, about 10 mm or less, about 5 mm or less, about 3 mm or more, about 5 mm or more, about 8 mm or more, about 10 mm or more, or about 15 mm or more. In some embodiments, the foldable apparatus 101, 301, 401, and/or 601 can comprise an effective minimum bend radius in a range from about 3 mm to about 50 mm, from about 5 mm to about 50 mm, from about 5 mm to about 40 mm, from about 8 mm to about 40 mm, from about 8 mm to about 30 mm, from about 10 mm to about 30 mm, from about 10 mm to about 20 mm, from about 15 mm to about 20 mm, or any range or subrange therebetween.

A minimum force may be used to achieve a predetermined parallel plate distance with the foldable apparatus. The parallel plate apparatus of FIG. 8, described above, is used to measure the “closing force” of a foldable apparatus of the embodiments of the disclosure. The force to go from the first configuration (e.g., see FIGS. 1-3) to the second configuration (e.g., see FIG. 4-6) comprising the predetermined parallel plate distance is measured. In some embodiments, the force per width 103 to bend the foldable substrate and/or the foldable apparatus from the first configuration comprising a bend angle of about 100° to a parallel plate distance of 10 mm can be about 20 Newtons per millimeter (N/mm) or less, about 0.15 N/mm or less, about 0.12 N/mm or less, about 0.10 N/mm or less, about 0.001 N/mm or more, about 0.005 N/mm or more, about 0.01 N/mm or more, about 0.02 N/mm or more, about 0.05 N/mm or more. In some embodiments, the force per width 103 to bend the foldable substrate and/or the foldable apparatus from the first configuration comprising a bend angle of about 100° to a parallel plate distance of 10 mm can be in a range from about 0.001 N/mm to about 0.20 N/mm, from about 0.005 N/mm to about 0.20 N/mm, from about 0.005 N/mm to about 0.15 N/mm, from about 0.01 N/mm to about 0.15 N/mm, from about 0.01 N/mm to about 0.12 N/mm, from about 0.02 N/mm to about 0.12 N/mm, from about 0.02 N/mm to about 0.10 N/mm, from about 0.05 N/mm to about 0.10 N/mm, or any range or subrange therebetween. In some embodiments, the force per width 103 to bend the foldable substrate and/or the foldable apparatus from a first configuration comprising a bend angle of about 100° to a parallel plate distance of 3 mm can be about 0.10 N/mm or less, about 0.08 N/mm or less, about 0.06 N/mm or less, about 0.04 N/mm or less, about 0.03 N/mm or less, about 0.0005 N/mm or more about 0.001 N/mm or more, about 0.005 N/mm or more, about 0.01 N/mm or more, about 0.02 N/mm or more, about 0.03 N/mm or more. In some embodiments, the force per width 103 to bend the foldable substrate and/or the foldable apparatus from the first configuration comprising a bend angle of about 100° to a parallel plate distance of 3 mm can be in a range from about 0.0005 N/mm to about 0.10 N/mm, from about 0.001 N/mm to about 0.10 N/mm, from about 0.001 N/mm to about 0.08 N/mm, from about 0.005 N/mm to about 0.08 N/mm, from about 0.005 N/mm to about 0.06 N/mm, from about 0.01 N/mm to about 0.06 N/mm, from about 0.01 N/mm to about 0.04 N/mm, from about 0.02 N/mm to about 0.04 N/mm, from about 0.02 N/mm to about 0.03 N/mm, or any range or subrange therebetween.

The foldable substrate 201 can comprise a neutral stress configuration. Throughout the disclosure, the “neutral stress configuration” is measured with the following test configuration and process. When measuring the “neutral stress configuration”, the foldable test apparatus 701 as shown in FIGS. 7-8 comprises the test adhesive layer 709 comprising an optically clear adhesive with an elastic modulus of 0.1 MPa and a thickness of 50 μm between the sixth contact surface 715 of the test adhesive layer 709 and the fifth contact surface 713 of the test adhesive layer 709 as well as a 100 μm thick sheet 707 of polyethylene terephthalate (PET), as described above with reference to FIG. 7 of determining the parallel plate distance and/or effective bend radius. To test the foldable test apparatus 701, the foldable test apparatus 701 is placed on its side such that a cross-section taking perpendicular to the direction of gravity resembles FIG. 7. The foldable test apparatus 701 rests on a surface comprising SAE grade 304 (e.g., ISO A2) stainless steel with an arithmetic mean deviation of the surface (surface roughness (Ra)) of 3 μm or less (e.g., 2.40 μm, mill finish number 3). As shown, a plane substantially comprising the direction 202 of the substrate thickness 207 and the direction 106, 108 of the length (see FIG. 1, first length 105, second length 107) of the foldable apparatus is substantially perpendicular to the direction of gravity while the direction 104 (see FIG. 1) of the fold axis 102 is in the direction of gravity. Then, the test foldable apparatus is allowed to relax 1 hour to achieve an equilibrium configuration, as shown in FIG. 7.

In some embodiments, as shown in FIG. 7, the neutral stress configuration can comprise a bent configuration. As used herein a bent configuration is a non-flat configuration. In further embodiments, as shown in FIG. 7, the first major surface 203 and/or the second major surface 205 of the foldable substrate 201 may substantially deviate from a shape of a plane. In some embodiments, the deviation of the neutral stress configuration from the flat configuration can be quantified using a maximum magnitude of a deviatoric strain. As used herein, “deviatoric strain” means the shape-changing component of the strain tensor (e.g., the strain tensor minus the as the hydrostatic strain—average of the on-diagonal components of the strain tensor). The strain tensor can be measured using digital image recognition and/or topography of a portion (e.g., polymer-based portion) of the folded apparatus to compare the shape and dimensions between the flat configuration and the neutral stress configuration. For example, a portion of material in a flat configuration can comprise an initial length that is substantially equal when measured at a first surface or a second surface opposite the first surface. When the portion of material is in a bent neutral stress configuration and the volume of the portion is the same as in the flat configuration (e.g., after removing the hydrostatic strain from the digitally captured shape and dimensions of the neutral stress configuration, a first length measured along the first surface can be (e.g., greater than) a second length measured along the second surface. As used herein, strain means the difference in length of a portion between a flat configuration and a neutral stress configuration divided by a reference length (e.g., initial length) from the flat configuration. For example, a strain (e.g., deviatoric strain when the hydrostatic strain is removed as discussed above) between the flat configuration and the neutral stress configuration for the portion discussed above measured at the first surface would be equal to the difference of the first length in the neutral stress configuration and the initial length in the flat configuration divided by the initial length in the flat configuration. For example, a strain (e.g., deviatoric strain when the hydrostatic strain is removed as discussed above) between the flat configuration and the neutral stress configuration for the portion discussed above measured at the second surface would be equal to the difference of the second length in the neutral stress configuration and the initial length in the flat configuration divided by the initial length in the flat configuration. As used herein, the magnitude of a value (e.g., scalar value) is the absolute value of the value. As used herein, the maximum magnitude of a tensor (e.g., strain tensor, deviatoric strain tensor) means the component of the tensor (e.g., deviatoric strain tensor) with the largest (e.g., maximum) value. As used herein, the maximum magnitude of the deviatoric strain of foldable substrate 201, means the largest value of the maximum magnitude of the deviatoric strain calculated at the first major surface 203 and the second major surface 205 of the foldable substrate 201. In some embodiments, the maximum magnitude of the deviatoric strain of the foldable substrate 201 can be about 1% or more, about 2% or more, about 3% or more, about 4% or more, about 10% or less, about 8% or less, about 7% or less, about 6% or less, or about 5% or less. In some embodiments, the maximum magnitude of the deviatoric strain of the foldable substrate 201 can be in a range from about 1% to about 10%, from about 1% to about 8%, from about 1% to about 7%, from about 2% to about 7%, from about 2% to about 6%, from about 2% to about 5%, from about 3% to about 5%, from about 3% to about 4%, from about 2% to about 10%, from about 2% to about 8%, from about 3% to about 8%, from about 4% to about 8%, from about 4% to about 7%, from about 4% to about 6%, or any range or subrange therebetween.

In some embodiments, the deviation of the neutral stress configuration from the flat configuration can be quantified using an angle “B” measured between a first line extending in the direction of the length from the first portion and a second line extending in the direction of the length from the second portion. For example, with reference to FIG. 7, the angle “B” is measured between a first line 702 and a second line 704. The first line 702 extends in the direction 106 of the length of the foldable test apparatus 701 at and from a portion of the first major surface 203 of the foldable substrate 201 in the first portion 251. The second line 704 extends in the direction 108 of the length of the foldable test apparatus 701 at and from a portion of the first major surface 203 of the foldable substrate 201 in the second portion 261. As used herein, the region swept out by the angle “B” includes the foldable substrate 201 without including the first line 702 or the second line 704 other than at the endpoints of the range, and the angle “B” is reported as a positive value in degrees less than 180°(e.g., |B|, |360°—B|). In some embodiments, the magnitude of the difference (i.e., |180°—B|) between the angle “B” in the neutral stress configuration and the flat configuration (e.g., 180°) can be about 1° or more, about 2° or more, about 5° or more, about 10° or more, about 40° or less, about 20° or less, about 15° or less, or about 8° or less. In some embodiments, the magnitude of the difference (i.e., |180°—B|) between the angle “B” in the neutral stress configuration and the flat configuration (e.g., 180°) can be in a range from about 1° to about 40°, from about 1° to about 20°, from about 2° to about 20°, from about 5° to about 20°, from about 5° to about 15°, from about 10° to about 15°, from about 2° to about 15°, from about 5° to about 15°, from about 5° to about 8°, from about 1° to about 8°, from about 2° to about 8°, or any range or subrange therebetween.

In some embodiments, the neutral stress configuration can be characterized by a parallel plate distance. The parallel plate distance corresponding to the neutral stress configuration is the maximum distance between a first plane intersecting the first major surface 203 of the foldable substrate 201 at only one point or along a line in the first portion 251 and a second plane intersecting the first major surface 203 of the foldable substrate 201 at only one point or along a line in the second portion 261, as if the pair of parallel plates 803 and 805 discussed above with reference to FIG. 8 were imposed with no added force and/or stress on the foldable substrate. As used herein, the parallel plate distance of the foldable substrate 201 in the neutral stress configuration corresponds to a length of 100 mm centered about the fold axis 102 (see FIGS. 7-8), where the length extends along the path of the foldable substrate 201 and, if the foldable substrate 201 is shorter than the 100 mm length, continues extending in the direction at the corresponding end of the foldable substrate 201. In some embodiments, the parallel plate distance of the foldable substrate 201 (e.g., foldable test apparatus 701) in the neutral stress configuration can be about 20 mm or more, about 30 mm or more, about 40 mm or more, about 50 mm or more, about 60 mm or more, about 80 mm or more, about 200 mm or less, about 180 mm or less, about 160 mm or less, about 140 mm or less, about 120 mm or less, or about 100 mm or less. In some embodiments, the parallel plate distance of the foldable substrate 201 (e.g., foldable test apparatus 701) in the neutral stress configuration can be in a range from about 20 mm to about 200 mm, from about 20 mm to about 180 mm, from about 30 mm to about 180 mm, from about 30 mm to about 160 mm, from about 40 mm to about 160 mm, from about 40 mm to about 140 mm, from about 50 mm to about 140 mm, from about 50 mm to about 120 mm, from about 60 mm to about 120 mm, from about 60 mm to about 100 mm, from about 80 mm to about 100 mm, or any range or subrange therebetween.

By providing a neutral stress configuration when the foldable substrate and/or the foldable apparatus is in a bent configuration, the force to bend the foldable apparatus to a predetermined parallel plate distance can be reduced. Further, providing a neutral stress configuration when the foldable apparatus is in a bent state can reduce the maximum stress and/or strain experienced by the foldable substrate and/or other components of the foldable apparatus during normal use conditions, which can, for example, enable reduced substrate thickness, increased durability and/or reduced fatigue of the foldable apparatus. In some embodiments, the neutral stress configuration can be generated by bending a ribbon at an elevated temperature (e.g., when the ribbon comprises a viscosity in a range from about 10⁴ Pascal-seconds and about 10^{6.6} Pascal-seconds) to form the foldable substrate.

The foldable apparatus may have an impact resistance defined by the capability of a region of the foldable apparatus (e.g., the first portion 251, second portion 261, and/or central portion 271 of the foldable substrate 201) to avoid failure at a pen drop height (e.g., 5 centimeters (cm) or more, 10 centimeters or more, 20 cm or more), when measured according to the “Pen Drop Test.” As used herein, the “Pen Drop Test” is conducted such that samples of foldable apparatus are tested with the load (i.e., from a pen dropped from a certain height) imparted to an outer surface (e.g., the first major surface 203 of the foldable substrate 201) of the foldable apparatus. A “pen drop height” for the foldable substrate 201 refers to the Pen Drop Test performed on a foldable test apparatus 701 configured as in the parallel plate test with 100 μm thick sheet 707 of PET attached to the fifth contact surface 713 of the test adhesive layer 709. As such, the PET layer in the Pen Drop Test is meant to simulate a flexible electronic display device (e.g., an OLED device). A “pen drop height” for the foldable apparatus 101, 301, 401, and/or 601, refers to the Pen Drop Test performed on the corresponding foldable apparatus with the pen directed to a location on the first major surface 203 of the foldable substrate 201 with the corresponding foldable apparatus arranged and supported such that the pen impacts the location while traveling substantially in the direction of gravity. During testing, the foldable apparatus bonded to the PET layer is placed on an aluminum plate (6063 aluminum alloy, as polished to a surface roughness with 400 grit paper) with the PET layer in contact with the aluminum plate. No tape is used on the side of the sample resting on the aluminum plate. In contrast to the configuration for measuring the neutral stress configuration, where the fold axis 102 is in the direction of gravity and the foldable test apparatus 701 is supported by the aluminum plate, the pen drop height is measured with the aluminum plate contacting the 100 μm thick sheet 707 of PET with the fold axis 102 substantially perpendicular to the direction of gravity. For the pen drop test, measurements for the first portion 251 or the second portion 261 of the foldable substrate 201 are conducted with the corresponding portion is supported by a planar portion of the aluminum plate by placing the 100 μm thick sheet 707 of PET on the aluminum plate and the planar portion of the aluminum plate is perpendicular to the direction of gravity. For the pen drop test, measurements for a region (e.g., central portion 271) corresponding to the support 131 are conducted with the aluminum plate is configured (e.g., bent, formed, ground) to conform to the curvature of the corresponding portion of the foldable test apparatus 701 by placing the 100 μm thick sheet 707 of PET on the aluminum plate, a plane tangent to the foldable substrate 201 of the foldable test apparatus 701 at the location where the pen is dropped is perpendicular to the direction of gravity.

As used herein, the pen drop apparatus comprises the ballpoint pen. The pen employed in Pen Drop Test is a BIC Easy Glide Pen, Fine comprising a tungsten carbide ballpoint tip of 0.7 mm (0.68 mm) diameter, and a weight of 5.73 grams (g) including the cap (4.68 g without the cap). The ballpoint pen is held a predetermined height from an outer surface (e.g., the first major surface 203 of the foldable substrate 201) of the foldable apparatus 101, 301, 401, or 601 or the foldable test apparatus 701. A tube is used for the Pen Drop Test to guide the ballpoint pen to the outer surface of the foldable apparatus 101, 301, 401, or 601 or the foldable test apparatus 701, and the tube is placed in contact with the outer surface of the foldable apparatus 101, 301, 401, or 601 or the foldable test apparatus 701 so that the longitudinal axis of the tube is substantially perpendicular to the outer surface of the foldable apparatus 101, 301, 401, or 601 or the foldable test apparatus 701. The tube has an outside diameter of 1 inch (2.54 cm), an inside diameter of nine-sixteenths of an inch (1.4 cm) and a length of 90 cm. An acrylonitrile butadiene (“ABS”) shim is employed to hold the ballpoint pen at a predetermined height for each test. After each drop, the tube is relocated relative to the foldable apparatus 101, 301, 401, or 601 or the foldable test apparatus 701 to guide the ballpoint pen to a different impact location on the foldable apparatus 101, 301, 401, or 601 or the foldable test apparatus 701. It is to be understood that the Pen Drop Test can be used for any of the foldable apparatus of embodiments of the disclosure.

For the Pen Drop Test, the ballpoint pen is dropped with the cap attached to the top end (i.e., the end opposite the tip) so that the ballpoint tip can interact with the outer surface (e.g., the first major surface 203 of the foldable substrate 201) of the foldable apparatus 101, 301, 401, or 601 or the foldable test apparatus 701. In a drop sequence according to the Pen Drop Test, one pen drop is conducted at an initial height of 1 cm, followed by successive drops in 0.5 cm increments up to 20 cm, and then after 20 cm, 2 cm increments until failure of the foldable apparatus 101, 301, 401, or 601 or the foldable test apparatus 701. After each drop is conducted, the presence of any observable fracture, failure, or other evidence of damage to the foldable apparatus 101, 301, 401, or 601 or the foldable test apparatus 701 is recorded along with the particular predetermined height for the pen drop. Using the Pen Drop Test, multiple foldable apparatus (e.g., samples) can be tested according to the same drop sequence to generate a population with improved statistical accuracy. For the Pen Drop Test, the ballpoint pen is to be changed to a new pen after every 5 drops, and for each new foldable apparatus (e.g., foldable apparatus 101, 301, 401, or 601 or the foldable test apparatus 701) tested. In addition, all pen drops are conducted at random locations on the foldable apparatus 101, 301, 401, or 601 or the foldable test apparatus 701 at or near the center of the foldable apparatus 101, 301, 401, or 601 or the foldable test apparatus 701 unless indicated otherwise, with no pen drops near or on the edge of the foldable apparatus 101, 301, 401, or 601 or the foldable test apparatus 701.

For purposes of the Pen Drop Test, “failure” means the formation of a visible mechanical defect in the sample tested (e.g., foldable apparatus 101, 301, 401, or 601, the foldable test apparatus 701, and/or foldable substrate 201). The mechanical defect may be a crack or plastic deformation (e.g., surface indentation). The crack may be a surface crack or a through crack. The crack may be formed on an interior or exterior surface of a laminate. The crack may extend through all or a portion of the foldable substrate 201. A visible mechanical defect has a minimum dimension of 0.2 mm or more.

In some embodiments, the foldable apparatus can resist failure for a pen drop in a region comprising the first portion 251 or the second portion 261 of the foldable substrate 201 at a pen drop height of 10 centimeters (cm), 12 cm, 14 cm, 15 cm, 16 cm, or 20 cm. In some embodiments, a maximum pen drop height that the foldable apparatus can withstand without failure over a region comprising the first portion 251 or the second portion 261 of the foldable substrate 201 may be about 10 cm or more, about 12 cm or more, about 14 cm or more, about 16 cm or more, about 40 cm or less, or about 30 cm or less, about 20 cm or less, about 18 cm or less. In some embodiments, a maximum pen drop height that the foldable apparatus can withstand without failure over a region comprising the first portion 251 or the second portion 261 of the foldable substrate 201 can be in a range from about 10 cm to about 40 cm, from about 12 cm to about 40 cm, from about 12 cm to about 30 cm, from about 14 cm to about 30 cm, from about 14 cm to about 20 cm, from about 16 cm to about 20 cm, from about 18 cm to about 20 cm, or any range or subrange therebetween.

In some embodiments, the foldable apparatus can resist failure for a pen drop in a region (e.g., central portion 271) corresponding to the support 131 at a pen drop height of 2 cm, 5 cm, 8 cm, 10 cm, or 15 cm. In some embodiments, a maximum pen drop height that the foldable apparatus can withstand without failure over a region comprising the support 131 may be about 2 cm or more, about 5 cm or more, about 8 cm or more, about 10 cm or more, about 15 cm or less, about 30 cm or less, about 25 cm or less, or about 20 cm or less. In some embodiments, a maximum pen drop height that the foldable apparatus can withstand without failure over a region comprising the support 131 can be in a range from about 2 cm to about 30 cm, from about 5 cm to about 30 cm, from about 5 cm to about 25 cm, from about 8 cm to about 25 cm, from about 10 cm to about 25 cm, from about 15 cm to about 25 cm, from about 15 cm to about 20 cm, or any range or subrange therebetween.

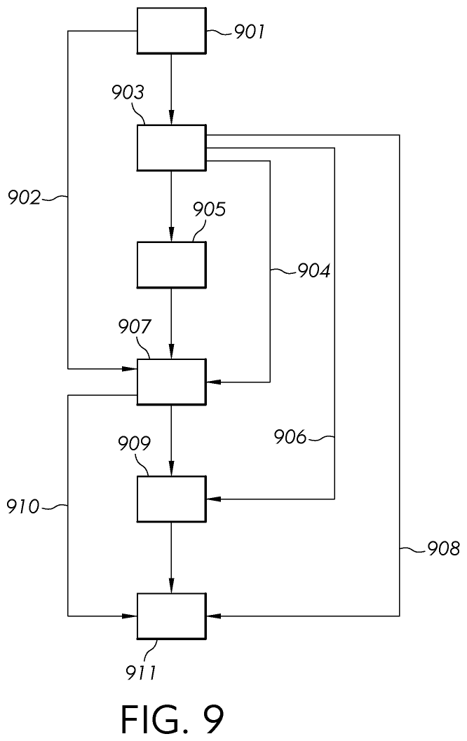

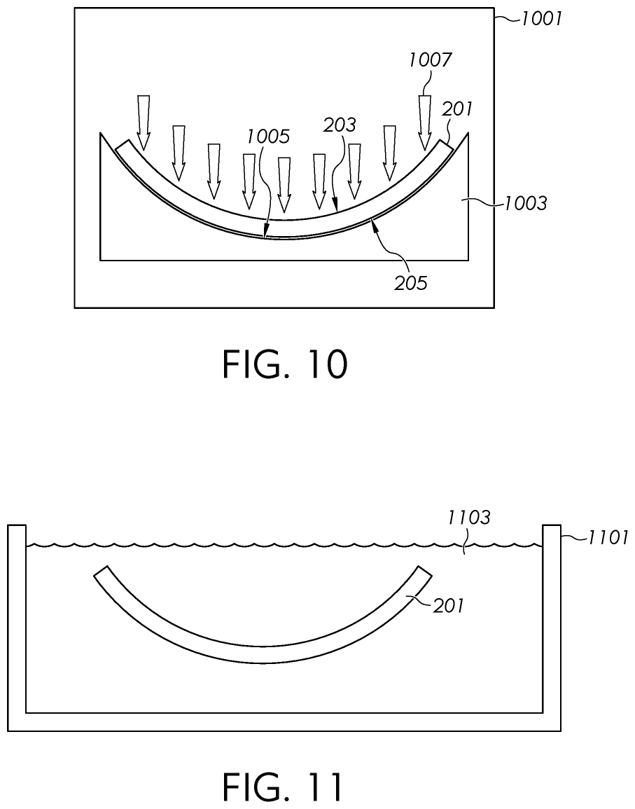

Embodiments of methods of making the foldable apparatus in accordance with embodiments of the disclosure will be discussed with reference to the flow chart in FIG. 9 and example method steps illustrated in FIGS. 10-11. Example embodiments of making the foldable apparatus 101, 301, 401, and/or 601 and/or foldable test apparatus 701 illustrated in FIGS. 1-8 will now be discussed with reference to FIGS. 10-11 and the flow chart in FIG. 9.

In a first step 901 of methods of the disclosure, methods can start with providing a foldable substrate 201. In some embodiments, the foldable substrate 201 may be provided by purchase or otherwise obtaining a substrate or by forming the substrate. In some embodiments, the foldable substrate 201 can comprise a glass-based substrate. In further embodiments, glass-based substrates can be provided by forming them with a variety of ribbon forming processes, for example, slot draw, down-draw, fusion down-draw, up-draw, press roll, redraw, or float. The foldable substrate 201 may comprise a second major surface 205 that can extend along a second plane. The second major surface 205 can be opposite a first major surface 203 that can extend along a first plane. In some embodiments, at the end of step 901 the foldable substrate 201 can comprise a ribbon of molten material that can be cooled to form a glass-based substrate and/or a ceramic-based substrate, for example, comprising a temperature above the anneal point temperature and/or the softening point temperature of the molten material.

After step 901, as illustrated in FIG. 10, the method can proceed to step 903 comprising heating the foldable substrate 201 at about an anneal point temperature for a period of time. In some embodiments, as shown in FIG. 10 can comprise heating the foldable substrate 201 in an oven 1001. In some embodiments, heating the foldable substrate 201 can comprise maintaining a temperature of the foldable substrate 201 at about the anneal point temperature of the foldable substrate. A relaxation time constant can be defined as a ratio of a viscosity of the foldable substrate at the anneal point temperature to a shear modulus of the foldable substrate at 23° C. Without wishing to be bound by theory, the fictive temperature can relax (e.g., decrease) to substantially a predetermined temperature (e.g., the anneal point temperature) when maintained at the predetermined temperature for about 30 times the relaxation time constant or more. In some embodiments, the period of time that the foldable substrate 201 is heated (e.g., maintained) at about the anneal point temperature as a multiple of the relaxation time constant for the foldable substrate 201 can be about 30 times or more, about 33 times or more, about 35 times or more, about 38 times or more, about 40 times or more, about 120 times or less, about 90 times or less, about 75 times or less, or about 60 times or less. In some embodiments, the period of time that the foldable substrate 201 is heated (e.g., maintained) at about the anneal point temperature as a multiple of the relaxation time constant for the foldable substrate 201 can be in a range from about 30 times to about 120 times, from about 30 times to about 90 times, from about 33 times to about 90 times, from about 33 times to about 75 times, from about 35 times to about 75 times, from about 35 times to about 60 times, from about 38 times to about 60 times, from about 38 times to about 45 times, from about 40 times to about 45 times, or any range or subrange therebetween. In some embodiments, the period of time that the foldable substrate 201 is heated (e.g., maintained) at about the anneal point temperature as a multiple of the relaxation time constant for the foldable substrate 201 can be in a range from about 30 times to about 45 times, from about 30 times to about 40 times, from about 31 times to about 40 times, from about 31 times to about 38 times, from about 32 times to about 36 times, from about 33 times to about 35 times, or any range or subrange therebetween. In some embodiments, the period of time that the foldable substrate 201 is heated (e.g., maintained) at about the anneal point temperature can be about 20 minutes or more, about 30 minutes or more, about 40 minutes or more, about 50 minutes or more, about 1 hours or more, about 1.5 hours or more, about 168 hours or less, about 96 hours or less, about 24 hours or less, about 12 hours or less, about 6 hours or less, about 3 hours or less, or about 2 hours or less. In some embodiments, the period of time that the foldable substrate 201 is heated (e.g., maintained) at about the anneal point temperature can be in a range from about 20 minutes to about 168 hours, from about 20 minutes to about 96 hours, from about 30 minutes to about 96 hours, from about 30 minutes to about 24 hours, from about 40 minutes to about 24 hours, from about 40 minutes to about 12 hours, from about 50 minutes to about 12 hours, from about 50 minutes to about 6 hours, from about 1 hour to about 6 hours, from about 1 hour to about 3 hours, from about 1.5 hours to about 3 hours, from about 1.5 hours to about 2 hours, or any range or subrange therebetween. In some embodiments, the period of time that the foldable substrate 201 is heated (e.g., maintained) at about the anneal point temperature can be in a range from about 20 minutes to about 3 hours, from about 20 minutes to about 2 hours, from about 30 minutes to about 2 hours, from about 30 minutes to about 1.5 hours, from about 40 minutes to about 1.5 hours, from about 40 minutes to about 1.25 hours, from about 50 minutes to about 1.25 hours, from about 50 minutes to about 1 hour, or any range or subrange therebetween.

After step 903 or during step 903, as shown in FIG. 10, the method can proceed to step 905 comprising forming the foldable substrate 201 into a non-planar configuration. In some embodiments, the forming the foldable substrate into a non-planar configuration can occur during the heating. For example, the foldable substrate 201 can be formed into a non-planar configuration once the anneal point temperature is reached, for example, at the beginning of the period of time or anytime thereafter. In some embodiments, the non-planar configuration can correspond to the neutral stress configuration described above. In some embodiments, the non-planar configuration can be characterized based on a maximum deviatoric strain, a parallel plate distance, or an angle (e.g., angle B shown in FIG. 8) of the bend that can be within one or more of the corresponding ranges discussed above for the neutral stress configuration with reference to FIG. 8. In further embodiments, as shown in FIG. 10, the forming the foldable substrate into a non-planar configuration can comprise using a mold 1003 comprising a mold surface 1005 comprising a convex shape corresponding to the predetermined shape of the concave second major surface 205 to be formed. In even further embodiments, as shown, pressure 1007 can be applied to the foldable substrate 201 (e.g., via the first major surface 203, or a vacuum applied via the second major surface 205), for example, pressing the foldable substrate into the mold 1003 to obtain the non-planar configuration. In some embodiments, the weight of the foldable substrate 201 may cause the foldable substrate 201 to conform to the shape of the mold surface 1005.

In still further embodiments, the mold surface 1005 of the mold 1003 can correspond to a parallel plate distance for the foldable substrate 201 in the mold 1003. As used herein, the parallel plate distance for the foldable substrate 201 in the mold 1003 is measured in the same way as the parallel plate distance for the neutral stress configuration with a 100 mm length centered at the center of the mold. In yet further embodiments, the parallel plate distance for the foldable substrate 201 in the mold 1003 can be in a range from about 20 mm to about 200 mm, from about 20 mm to about 180 mm, from about 30 mm to about 180 mm, from about 30 mm to about 160 mm, from about 40 mm to about 160 mm, from about 40 mm to about 140 mm, from about 50 mm to about 140 mm, from about 50 mm to about 120 mm, from about 60 mm to about 120 mm, from about 60 mm to about 100 mm, from about 80 mm to about 100 mm, or any range or subrange therebetween. In further embodiments, although not shown, other methods can be used to obtain the non-planar configuration, for example, sagging the foldable substrate using gravity. Providing a non-bent configuration of the foldable substrate when the foldable substrate is above its anneal point temperature can provide a neutral stress configuration substantially corresponding to the non-planar configuration obtained, for example, because stresses in the foldable substrate can relax at such a temperature.

After step 905, as shown in FIG. 11, methods can proceed to the step 907 comprising chemically strengthening the foldable substrate 201 (e.g., first major surface 203, second major surface 205), for example, if the foldable substrate comprises a glass-based substrate and/or a ceramic-based substrate. For example, chemically strengthening the substrate by ion exchange can occur when a first cation within a depth of a surface of a substrate is exchanged with a second cation within a salt solution that has a larger radius than the first cation. For example, a lithium cation within the depth of the surface of the substrate can be exchanged with a sodium cation or potassium cation within a salt solution. Consequently, the surface of the foldable substrate 201 is placed in compression and thereby chemically strengthened by the ion exchange process since the lithium cation has a smaller radius than the radius of the exchanged sodium cation or potassium cation within the salt solution 1103. Chemically strengthening the foldable substrate 201 can comprise contacting at least a portion of a foldable substrate 201 comprising lithium cations and/or sodium cations with a salt bath 1101 comprising salt solution 1103 comprising potassium nitrate, potassium phosphate, potassium chloride, potassium sulfate, sodium chloride, sodium sulfate, and/or sodium nitrate, whereby lithium cations and/or sodium cations diffuse from the foldable substrate 201 to the salt solution 1103 contained in the salt bath 1101. In some embodiments, the temperature of the salt solution 1103 can be in a range from about 300° C. to about 500° C., from about 360° C. to about 500° C., from about 400° C. to about 500° C., from about 300° C. to about 460° C., from about 360° C. to about 460° C., from about 400° C. to about 460° C., from about 300° C. to about 400° C., from about 360° C. to about 400° C., or any range or subrange therebetween. In some embodiments, the foldable substrate 201 can be in contact with the salt solution 1103 for a time in a range from about 15 minutes to about 48 hours, from about 1 hour to about 48 hours, from about 3 hours to about 48 hours, from about 15 minutes to about 24 hours, from about 1 hour to about 24 hours, from about 3 hours to about 48 hours, from about 3 hours to about 24 hours, from about 3 hours to about 8 hours, or any range or subrange therebetween. In some embodiments, the entire foldable substrate may be strengthened. In some embodiments, the first major surface 203 of the foldable substrate 201 can be chemically strengthened to form a first compressive stress region extending to a first depth of compression from the first major surface 203. The first depth of compression and/or a maximum compressive stress of the first compressive stress region can be within one or more of the ranges discussed above with reference to the first compressive stress region. In some embodiments, the second major surface 205 of the foldable substrate 201 can be chemically strengthened to form a second compressive stress region extending to a second depth of compression from the second major surface 205. The second depth of compression and/or a maximum compressive stress of the first compressive stress region can be within one or more of the ranges discussed above with reference to the second compressive stress region.

In some embodiments, step 907 can optionally further comprise etching the strengthened portion(s) of the foldable substrate 201 to remove less than 5-10 nanometers (nm) of a compressive stress layer generated by chemical strengthening. In some embodiments, the substrate can be etched by placing it in an etching bath comprising one or more mineral acids (e.g., HCl, HF, H₂SO₄, HNO₃). Etching to remove surface flaw microcracks in a surface of the foldable substrate can increase the puncture resistance (e.g., pen drop performance) of the foldable substrate and/or resulting foldable apparatus.

After step 907, methods can proceed to step 909 comprising attaching a first portion 251 of the foldable substrate 201 to an end portion 117 of a first inner surface area 113 of the first housing member 111, as shown in FIGS. 1-3 and 5-6. In some embodiments, as shown in FIGS. 2-3 and 5-6, the first portion 251 of the foldable substrate 201 can be attached to the end portion 117 of the first inner surface area 113 of the first housing member 111 using the first adhesive 211. In further embodiments, as shown, the first contact surface 213 of the first adhesive 211 can face and/or contact the second major surface 205 of the foldable substrate 201 in the first portion 251. In further embodiments, as shown, the second contact surface 215 of the first adhesive 211 can face and/or contact the first inner surface area 113 of the first housing member 111 (e.g., end portion 117). In some embodiments, step 909 can comprise attaching a second portion 261 of the foldable substrate 201 to an end portion 127 of a second inner surface area 123 of the second housing member 121, as shown in FIGS. 1-3 and 5-6. In some embodiments, as shown in FIGS. 2-3 and 5-6, the second portion 261 of the foldable substrate 201 can be attached to the end portion 127 of the second inner surface area 123 of the second housing member 121 using the second adhesive 221. In further embodiments, as shown, the third contact surface 223 of the second adhesive 221 can face and/or contact the second major surface 205 of the foldable substrate 201 in the second portion 261. In further embodiments, as shown, the fourth contact surface 225 of the second adhesive 221 can face and/or contact the second inner surface area 123 of the second housing member 121 (e.g., end portion 127). In some embodiments, the foldable substrate 201 can be attached to the first housing member 111 and/or second housing member 121 with a framing or other attachment means.

After step 909, method can proceed to step 911. In some embodiments, the foldable apparatus may be complete after step 909 and may resemble one of FIGS. 1-6. In further embodiments, step 911 may comprise disposing a coating on the first major surface 203 of the foldable substrate 201. In some embodiments, step 911 can comprise assembling the foldable apparatus, for example, by inserting one or more pins 241, 313, and/or 323 or otherwise attaching the support 131 (e.g., unitary support member 231, first support member 311, second support member 321) to the first housing member 111 and/or the second housing member 121. In further embodiments, step 911 can comprise providing a platform 341 and attaching the platform 341 to the foldable apparatus by inserting a pin 303. In further embodiments, step 911 can comprise providing a display device or other electronic device within one or more of the first housing member 111 and/or the second housing member 121.

After step 905, 907, 909, and/or 911, the foldable apparatus and/or the foldable substrate 201 can comprise a neutral stress configuration. In some embodiments, the neutral stress configuration can be characterized by a parallel plate distance within one or more of the ranges discussed above (e.g., from about 20 mm to about 200 mm, from about 40 mm to about 140 mm). In some embodiments, the neutral stress configuration can be characterized by a bend angle within one or more of the ranges discussed above. In some embodiments, the neutral stress configuration can be characterized by a maximum magnitude of a deviatoric strain of the foldable substrate 201 that can be within one or more of the ranges discussed above.

In some embodiments, methods of making a foldable apparatus in accordance with embodiments of the disclosure can proceed along steps 901, 903, 905, 907, 909, and 911 sequentially, as discussed above. In some embodiments, methods can follow arrow 902 from step 901 to step 907, omitting steps 903 and 905, for example, if the foldable substrate 201 already comprises a non-planar neutral stress configuration after step 901, the foldable substrate 201 already comprises a fictive temperature substantially equal to the anneal point temperature of the foldable substrate 201, or the foldable substrate 201 is not to comprise a non-planar neutral stress configuration and/or a fictive temperature substantially equal to its anneal point temperature. In some embodiments, methods can follow arrow 904 from step 903 to step 907, omitting step 905, for example, if the foldable substrate 201 already comprises a non-planar neutral stress configuration after step 903 or the foldable substrate 201 is not to comprise a non-planar neutral stress configuration. In some embodiments, methods can follow arrow 906 from step 903 to step 909, omitting steps 905 and 907, for example, if the foldable substrate 201 already comprises a non-planar neutral stress configuration after step 903, the foldable substrate 201 already comprises one or more compressive stress regions after step 903, or the foldable substrate 201 is not to comprise a non-planar neutral stress configuration and/or the foldable substrate is not to comprise a compressive stress region. In some embodiments, methods can follow step 908 from step 903 to step 911, omitting steps 905, 907, and 909, for example, if the foldable substrate 201 and/or foldable apparatus is complete after step 903 or the foldable test apparatus 701 is to be produced. In some embodiments, as shown by arrow 910, methods can follow step 907 to step 911, omitting step 909, for example, if the foldable substrate 201 and/or foldable apparatus is complete after step 907 or the foldable test apparatus 701 is to be produced. Any of the above options may be combined to make a foldable apparatus in accordance with embodiments of the disclosure.

### EXAMPLES

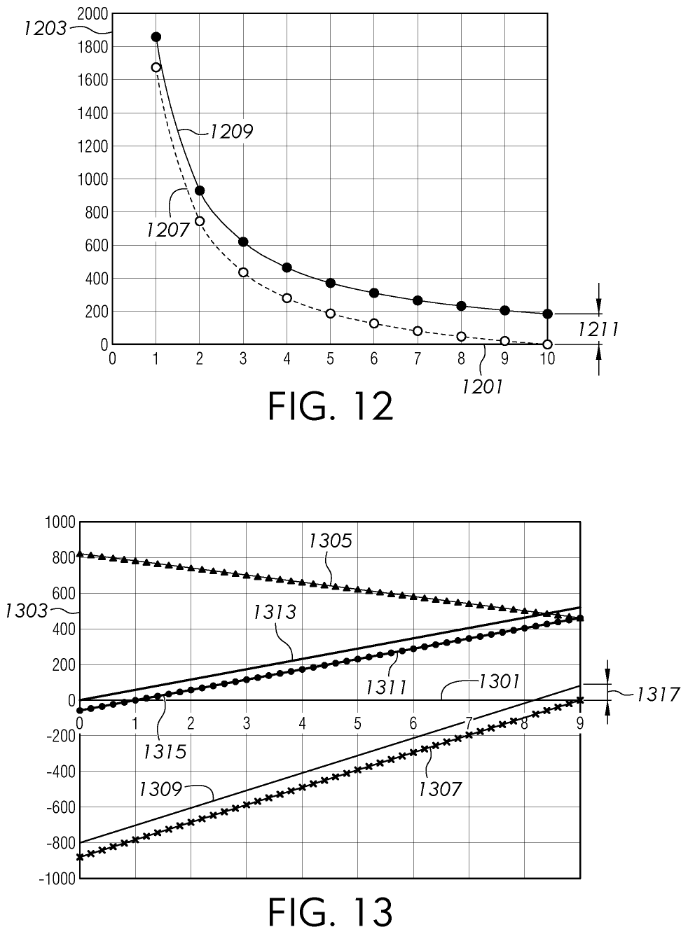

Various embodiments will be further clarified by the following examples. The examples were modeled using Abaqus software finite element analysis from Dassault Systems Simulia. The fold-induced stress of Examples D-E as a function of effective bend radius is presented in FIG. 12. The stress decrease from the neutral stress configuration at an effective bend radius of 10 mm is reported in Table 1. The net stress of chemically strengthening induced compressive stress and fold-induced stress as well as the component stresses are presented in FIG. 13 as a function of distance from the second major surface of the foldable substrate for Examples M-N.

Examples A-C comprise a foldable substrate comprising a glass-based substrate (having Composition 1 of, nominally, in mol % of: 69.1 SiO₂; 10.2 Al₂O₃; 15.1 Na₂O; 0.01 K₂O; 5.5 MgO; 0.09 SnO₂) and a substrate thickness of 25 μm. Examples D-F and M-N comprise a foldable substrate comprising a glass-based substrate (having Composition 1) and a substrate thickness of 50 μm. Examples G-I comprise a foldable substrate comprising a glass-based substrate (having Composition 1) and a substrate thickness of 75 μm. Examples J-L comprise a foldable substrate comprising a glass-based substrate (having Composition 1) and a substrate thickness of 100 μm.

In FIG. 12, the horizontal axis 1201 (e.g., x-axis) is the effective bend radius of the foldable substrate (in mm), and the vertical axis 1203 (e.g., y-axis) is the fold-induced stresses on the second major surface of the foldable substrate (in MegaPascals (MPa)). The results for Example D are shown by curve 1209, and the results for Example E are shown by curve 1207. Example D comprised a substantially planar neutral stress configuration while Example E comprised a neutral stress configuration in a substantially non-planar configuration comprising an effective bend radius of 10 mm. As shown, the stress for Example E (curve 1207) is less than the stress for Example D (curve 1209) for the same effective bend radius. For example, at an effective bend radius of 10 mm, Example E (curve 1207) comprises a stress of 0 MPa because it at its neutral stress configuration while Example D (curve 1209) comprise a stress of about 200 MPa (e.g., 186 MPa), meaning that the stress of Example E is about 200 MPa less than the corresponding stress of Example D at an effective bend radius of 10 mm. Likewise, at 5 mm, Example D (curve 1209) comprises a stress of about 400 MPa while Example E (curve 1207) comprises a stress of about 200 MPa, meaning that the stress of Example E is about 200 MPa (e.g., 186 MPa) less than the corresponding stress of Example D at an effective bend radius of 10 mm. Without wishing to be bound by theory, as discussed above, the stress difference be two samples comprising different neutral stress configuration can be characterized by a constant stress difference across effective bend radii less than the tighter neutral stress configuration. As used herein, the stress difference refers to the difference in bend-induced stress at an effective bend radius of 10 mm between the Example and another foldable substrate comprising the same substrate thickness but a neutral stress configuration in a substantially planar configuration. As shown in FIG. 12, the stress difference 1211 between Example D and Example E is about 200 MPa (e.g., 186 MPa).

Table 1 presents the stress difference for Examples A-L calculated between a foldable substrate comprising the same thickness as the corresponding Example but a neutral stress configuration in a substantially planar configuration. The substrate thickness and neutral stress configuration of Examples A-L are stated in Table 1. Without wishing to be bound by theory, the stress difference may be substantially constant for effective bend radii equal to or less than the effective bend radius corresponding to the neutral stress configuration. For example, the stress differences reported in Table can be measured at an effective bend radius of 10 mm, although a smaller bend radius could be used and the stress differences are expected to be substantially the same. For a substrate thickness of 25 μm, Example A comprises a neutral stress configuration of 10 mm effective bend radius produces a stress difference of 93 MPa while Example B comprising a neutral stress configuration of 20 mm effective bend radius produces a stress difference of 46 MPa and Example C comprising a neutral stress configuration of 40 mm effective bend radius produces a stress difference of 23 MPa. As the effective bend radius of the neutral stress configuration increases (e.g., less tight), the stress difference decreases. Comparing Example A and Example E both comprising a neutral stress configuration of 10 mm, the stress difference increases from 93 MPa for Example A comprising a substrate thickness of 25 μm to 186 MPa for Example E comprising a substrate thickness of 50 MPa. As such, increasing substrate thickness is associated with a greater stress difference.

TABLE 1
Stress Difference for Examples A-L

| | Substrate | Neutral Stress | Stress Difference |
|---|---|---|---|
| Example | Thickness (μm) | Configuration (mm) | (MPa) |
| A | 25 | 10 | 93 |
| B | 25 | 20 | 46 |
| C | 25 | 40 | 23 |
| D | 50 | Planar | 0 |
| E | 50 | 10 | 186 |
| F | 50 | 20 | 93 |
| G | 75 | 10 | 279 |
| H | 75 | 20 | 140 |
| I | 75 | 50 | 70 |
| J | 100 | 10 | 372 |
| K | 100 | 20 | 186 |
| L | 100 | 50 | 93 |

In FIG. 13, the horizontal axis 1301 (e.g., x-axis) is a depth from the second major surface of the foldable substrate (in μm), and the vertical axis 1303 (e.g., y-axis) is stress (in MegaPascals (MPa)) with negative stresses (−) corresponding to compressive stresses and positive stresses (+) corresponding to tensile stresses. FIG. 13 presents stress curves for Examples M-N. Examples M-N comprise a foldable substrate comprising a glass-based substrate (having Composition 1) comprising a substrate thickness of 50 μm, a substantially planar neutral stress configuration, and are measured at an effective bend radius of 2.55 mm. Example M comprising a fictive temperature of about 740° C., which is greater than the anneal point temperature of 652°. Example N was heated at 652° C. for about 26 minutes (e.g., about 30 times the relaxation time constant) to achieve a fictive temperature substantially equal to the anneal point temperature of 652° C. Examples M-N were chemically strengthened in 100% potassium nitrate at 400° C. for 20 minutes. Example M comprises a maximum compressive stress from the chemically strengthening of 792 MPa (−792 MPa at the second major surface) while Example N comprises a maximum compressive stress from the chemically strengthening of 882 MPa (−882 MPa at the second major surface).

In FIG. 13, curve 1305 corresponds to the bend-induced stress at an effective bend radius of 2.55 mm. In FIG. 13 for Example M, curve 1309 corresponds to the chemically strengthening induced stresses while curve 1313 corresponds to the sum of curve 1305 and curve 1309. In FIG. 13 for Example N, curve 1307 corresponds to the chemically strengthening induced stresses while curve 1311 corresponds to the sum of curve 1305 and curve 1307. The difference 1317 between the chemically strengthening induced stress for Example N (curve 1307) and Example M (curve 1309) is about 90 MPa. Consequently, the difference between curves 1313 and 1311 is also about 90 MPa. As shown in FIG. 13, curve 1313 comprises a net stress of 0 MPa at the second major surface and a net stress of 90 MPa at 1 μm from the second major surface for Example M. As shown in FIG. 13, curve 1311 comprises a net stress of −90 MPa at the second major surface and a net stress of 0 MPa at 1 μm from the second major surface for Example N. Comparing curves 1313 and 1311, the point where the stress is 0 MPa is shifted from the second major surface for Example M (curve 1311) to a depth 1315 of 1 μm from the second major surface. Providing a fictive temperature substantially equal to the anneal point temperature can increase a maximum compressive stress of the compressive stress region(s) achieved by subsequently chemically strengthening the foldable substrate, which can enable durability and/or reduced fatigue of the foldable apparatus. Providing increased compressive stresses can enable the foldable substrate to better withstand bend-induced stresses, for example, countering tensile bend-induced stresses.

The above observations can be combined to provide foldable apparatus comprising foldable substrate with low effective minimum bend radii, high impact resistance, low closing force, and low-velocity failure. In some embodiments, the foldable substrate can comprise a fictive temperature substantially equal to an anneal point temperature and/or a neutral stress configuration in a non-planar configuration. The foldable substrate can comprise a glass-based substrate and/or a ceramic-based substrate, which can provide good impact resistance and/or good puncture resistance to the foldable apparatus. The foldable substrate can comprise a glass-based substrate and/or a ceramic-based substrate comprising one or more compressive stress regions, which can further provide increased impact resistance and/or increased puncture resistance. Providing a foldable substrate comprising a glass-based substrate and/or ceramic-based substrate can also provide increased impact resistance and/or increased puncture resistance while simultaneously facilitating good folding performance.

By providing a neutral stress configuration when the foldable substrate and/or the foldable apparatus is in a bent configuration, the force to bend the foldable apparatus to a predetermined parallel plate distance can be reduced. Further, providing a neutral stress configuration when the foldable apparatus is in a bent state can reduce the maximum stress and/or strain experienced by the foldable substrate and/or other components of the foldable apparatus during normal use conditions, which can, for example, enable increased durability and/or reduced fatigue of the foldable apparatus. In some embodiments, the neutral stress configuration can be generated by forming a ribbon (e.g., foldable substrate) at an elevated temperature (e.g., when the ribbon comprises a viscosity in a range from about 10⁴ Pascal-seconds and about 10⁷ Pascal-seconds and/or about an anneal point temperature) to form the foldable substrate.

Providing a lower fictive temperature (e.g., a fictive temperature substantially equal to the anneal point temperature) can increase the density of the foldable substrate (e.g., decreased molar volume, compaction) and can enable greater compressive stresses to be developed as a result of chemically strengthening the foldable substrate, for example, because the larger ions exchanged into the foldable substrate create larger stresses in a denser substrate because an average spacing between atoms is smaller in such substrates. Providing increased compressive stresses can enable durability and/or reduced fatigue of the foldable apparatus. Providing increased compressive stresses can enable the foldable substrate to better withstand bend-induced stresses, for example, countering tensile bend-induced stresses. Providing a compressive stress region can provide good impact resistance and/or good puncture resistance of the foldable substrate. For example, providing a foldable substrate comprising a first depth of compression and/or a second depth of compression in a range from about 1% to about 30% of the substrate thickness, good impact resistance, good puncture resistance, and/or good folding performance can be enabled. For example, providing a first maximum compressive stress and/or a second maximum compressive stress in a range from about 500 MPa to about 1,500 MPa, good impact resistance, good puncture resistance, and/or good folding performance can be enabled.

In some embodiments, the foldable apparatus can comprise a first housing member, a second housing member, and a support. Providing a support that contacts the central portion of the foldable substrate in a first configuration can reduce the incidence and/or extent of damage to the foldable substrate, for example by supporting the second major surface of the foldable substrate, which can enable good impact resistance and/or good puncture resistance of the foldable substrate. Providing an elastic modulus of the support that is less than an elastic modulus of the foldable substrate can help the foldable substrate withstand impacts, for example, by absorbing and dissipating some of the impact's energy while supporting the foldable substrate. Further, the support contacts the second major surface of the foldable substrate when the foldable apparatus is in a first configuration, which is when the foldable substrate is most vulnerable to impacts. In further embodiments, the first housing member, the second housing member, and the support can form a substantially continuous inner surface area, which can enable increased impact resistance and/or puncture resistance of the foldable substrate across the entire first major surface of the foldable substrate.

Providing a support that contacts the second major surface of the foldable substrate in the first configuration and is spaced from the second major surface of the foldable substrate can enable folding of the foldable apparatus into a compact configuration. For example, the foldable substrate can comprise a unitary support member that can enable a central portion of the foldable substrate positioned in a reception area to comprise a greater separation (e.g., first maximum spacing distance) than a second maximum spacing distance between the first portion of the foldable substrate and the second portion of the foldable substrate, which can facilitate folding the foldable apparatus into a compact configuration by providing a reception area to receive the central portion of the foldable substrate comprising the first maximum spacing distance. For example, providing a first support member and/or a second support member pivotably (e.g., pin-in-slot) attached to the first housing member and/or the second housing member can pivot to define a reception area in transitioning from the first configuration to the second configuration that can enable a compact second configuration of the foldable substrate. Further, the first housing member, second housing member, and support can protect the foldable substrate from damage in the second configuration.

Providing a coating can reduce folding-induced stresses of the foldable substrate. Providing a coating can reduce the force to achieve a small parallel plate distance (e.g., about 10 Newtons (N) or less to achieve a parallel plate distance of 10 mm, about 3 N or less to achieve a parallel plate distance of about 3 mm). Providing a coating can also improve the scratch resistance, the impact resistance, and/or the puncture resistance of the foldable apparatus while simultaneously facilitating good folding performance. The coating can enable low forces to achieve small parallel plate distances, for example, by shifting a neutral axis of the foldable substrate portion away from the coating (e.g., surface facing the user) when the coating has an elastic modulus less than an elastic modulus of a glass-based substrate and/or the coating has a thickness of about 200 μm or less. Further, providing a coating on the substrate can provide low energy fracture, for example, low-velocity ejection of shards upon failure of the foldable apparatus (e.g., when it is pushed beyond its design limits) and/or can comprise shards comprising an aspect ratio of about 3 or less.

Directional terms as used herein—for example, up, down, right, left, front, back, top, bottom—are made only with reference to the figures as drawn and are not intended to imply absolute orientation.

It will be appreciated that the various disclosed embodiments may involve features, elements, or steps that are described in connection with that embodiment. It will also be appreciated that a feature, element, or step, although described in relation to one embodiment, may be interchanged or combined with alternate embodiments in various non-illustrated combinations or permutations.

It is also to be understood that, as used herein the terms “the,” “a,” or “an,” mean “at least one,” and should not be limited to “only one” unless explicitly indicated to the contrary. For example, reference to “a component” comprises embodiments having two or more such components unless the context clearly indicates otherwise. Likewise, a “plurality” is intended to denote “more than one.”

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. Ranges can be expressed herein as from “about” one particular value, and/or to “about” another particular value. When such a range is expressed, embodiments include from the one particular value and/or to the other particular value. Similarly, when values are expressed as approximations, by use of the antecedent “about,” it will be understood that the particular value forms another embodiment. Whether or not a numerical value or endpoint of a range in the specification recites “about,” the numerical value or endpoint of a range is intended to include two embodiments: one modified by “about,” and one not modified by “about.” It will be further understood that the endpoints of each of the ranges are significant both in relation to the other endpoint and independently of the other endpoint.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, as defined above, “substantially similar” is intended to denote that two values are equal or approximately equal. In some embodiments, “substantially similar” may denote values within about 10% of each other, for example, within about 5% of each other, or within about 2% of each other.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

While various features, elements or steps of particular embodiments may be disclosed using the transitional phrase “comprising,” it is to be understood that alternative embodiments, including those that may be described using the transitional phrases “consisting” or “consisting essentially of,” are implied. Thus, for example, implied alternative embodiments to an apparatus that comprises A+B+C include embodiments where an apparatus consists of A+B+C and embodiments where an apparatus consists essentially of A+B+C. As used herein, the terms “comprising” and “including”, and variations thereof shall be construed as synonymous and open-ended unless otherwise indicated.

The above embodiments, and the features of those embodiments, are exemplary and can be provided alone or in any combination with any one or more features of other embodiments provided herein without departing from the scope of the disclosure.

It will be apparent to those skilled in the art that various modifications and variations can be made to the present disclosure without departing from the spirit and scope of the disclosure. Thus, it is intended that the present disclosure cover the modifications and variations of the embodiments herein provided they come within the scope of the appended claims and their equivalents.

1. A foldable apparatus comprising a foldable substrate comprising:
a substrate thickness defined between a first major surface and a second major surface opposite the first major surface; and
a central portion positioned between a first portion and a second portion in a direction of a length of the foldable substrate,
wherein the foldable substrate comprises a neutral stress configuration at a parallel plate distance in a range from about 20 millimeters to about 200 millimeters.

2. The foldable apparatus of claim 1, wherein the foldable substrate comprises a fictive temperature substantially equal to an anneal point temperature of the foldable substrate.

3. The foldable apparatus of claim 1, wherein the foldable substrate comprises a first compressive stress region extending to a first depth of compression from the first major surface, and the foldable substrate comprises a second compressive stress region extending to a second depth of compression from the second major surface, wherein the first depth of compression is in a range from about 15% to about 25% of the substrate thickness, and the second depth of compression is in a range from about 15% to about 25% of the substrate thickness.

4. The foldable apparatus of claim 3, wherein the first compressive stress region comprises a first maximum compressive stress in a range from about 500 MegaPascals to about 1,500 MegaPascals, and the second compressive stress region comprises a second maximum compressive stress in a range from about 500 MegaPascals to about 1,500 MegaPascals.

5. The foldable apparatus of claim 1, wherein the substrate thickness is in a range from about 25 micrometers to about 2 millimeters.

6. The foldable apparatus of claim 1, wherein the foldable substrate is configured to achieve an effective bend radius of 5 millimeters.

7. A consumer electronic product comprising:
a housing comprising a front surface, a back surface, and side surfaces;
electrical components at least partially within the housing, the electrical components comprising a controller, a memory, and a display, the display at or adjacent to the front surface of the housing; and
a cover substrate disposed over the display,
wherein at least one of a portion of the housing or the cover substrate comprises the foldable apparatus of claim 1.

8. A method of processing a foldable substrate comprising a substrate thickness defined between a first major surface and a second major surface opposite the first major surface, the method comprising:
heating the foldable substrate at about an anneal point temperature for a period of time from about 20 minutes to about 168 hours;
forming the foldable substrate into a non-planar configuration during the heating; and
chemically strengthening the foldable substrate,
wherein the foldable substrate comprises a neutral stress configuration at a parallel plate distance in a range from about 20 millimeters to about 200 millimeters.

9. The method of claim 8, wherein the period of time is equal to or greater than 30 times a ratio of a viscosity of the foldable substrate at the anneal point temperature to a shear modulus of the foldable substrate at 23° C.

10. The method of claim 8, wherein after the chemically strengthening, the foldable substrate comprises a first compressive stress region extending to a first depth of compression from the first major surface, and the foldable substrate comprises a second compressive stress region extending to a second depth of compression from the second major, wherein the first depth of compression is in a range from about 15% to about 25% of the substrate thickness, and the second depth of compression is in a range from about 15% to about 25% of the substrate thickness.

11. The method of claim 10, wherein the first compressive stress region comprises a first maximum compressive stress in a range from about 500 MegaPascals to about 1,500 MegaPascals, and the second compressive stress region comprises a second maximum compressive stress in a range from about 500 MegaPascals to about 1,500 MegaPascals.

12. The method of claim 8, wherein forming the foldable substrate into a non-planar configuration during the heating comprises pressing the foldable substrate into a mold comprising a non-planar configuration

13. The method of claim 12, wherein the mold corresponds to a parallel plate distance in a range from about 20 millimeters to about 200 millimeters.

14. The method of claim 8, wherein the foldable substrate is configured to achieve an effective bend radius of 5 millimeters.

15. A method of making a foldable apparatus comprising:
the method of making a foldable substrate of claim 8;
attaching the first portion of the foldable substrate to an end portion of a first inner surface area of a first housing member with a first adhesive, the end portion of the first housing member extending along a first plane; and
attaching the second portion of the foldable substrate to an end portion of a second inner surface area of a second housing member with a second adhesive, the end portion of the second housing member extending along a second plane.

16. The method of claim 15, further comprising forming a hingable connection between the first housing member and the second housing member.
